(19) United States
(12) Patent Application Publication
(10) Pub. No.: US 2026/0006623 A1
(43) Pub. Date: Jan. 1, 2026

(54) DOWNLINK INDICATION VIA ANTENNA PORT FIELD FOR UPLINK TRANSMISSION WITH ORTHOGONAL COVER CODES

(71) Applicant: QUALCOMM Incorporated, San Diego, CA (US)

(72) Inventors: Syed Hashim Ali SHAH, San Diego, CA (US); Alberto RICO ALVARINO, San Diego, CA (US)

(21) Appl. No.: 19/236,747

(22) Filed: Jun. 12, 2025

Related U.S. Application Data
(60) Provisional application No. 63/664,684, filed on Jun. 26, 2024.

(51) Int. Cl. H04W 72/232; H04L 5/00

(52) U.S. Cl. CPC H04W 72/232; H04L 5/0007

(57) ABSTRACT

Certain aspects of the present disclosure provide techniques for indicating orthogonal cover code (OCC) configurations via an antenna port field indication. A method generally includes receiving a downlink message that schedules an uplink message, where the downlink message includes an antenna port field; and sending the uplink message based on an OCC configuration that corresponds to the antenna port field. In some aspects, the antenna port field may indicate an entry within a table, where the table includes a plurality of OCC configurations (e.g., and/or at least one non-OCC configuration), and each OCC configuration of the plurality of OCC configurations may be associated with a respective value for the antenna port field.

### CROSS REFERENCE TO RELATED APPLICATION

The present Application for Patent claims priority to and benefit of U.S. Provisional Patent Application No. 63/664,684, filed Jun. 26, 2024, which is hereby expressly incorporated by reference herein in its entirety.

### INTRODUCTION

### Field of the Disclosure

Aspects of the present disclosure relate to wireless communications, and more particularly, to techniques for uplink transmissions with an orthogonal cover code (OCC) configuration.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes receiving a downlink message that schedules an uplink message, the downlink message comprising an antenna port field; and sending the uplink message based at least in part on an orthogonal cover code (OCC) configuration that corresponds to the antenna port field.

Another aspect provides a method for wireless communications by an apparatus. The method includes sending a downlink message that schedules an uplink message, the downlink message comprising an antenna port field; and receiving the uplink message based at least in part on an OCC configuration that corresponds to the antenna port field.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example non-terrestrial network (NTN).

FIG. 6 depicts an example wireless communications system.

FIG. 7 depicts an example orthogonal cover code (OCC) for uplink transmissions.

FIG. 8 depicts a process flow for communications in a network between a network entity and a device.

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for a downlink indication via an antenna port field for uplink transmissions with an orthogonal cover code (OCC) configuration.

A wireless communication system may include a number of devices (e.g., terminals, network entities, and other devices) exchanging data, control information, reference signals, etc. (e.g., communicating) with each other. In some examples, a wireless communication system may generally include or refer to a number of devices and network entities employing techniques for exchanging information wirelessly. For example, a wireless communication system may include terminals (e.g., user devices or user equipment (UE)) and network entities (e.g., base stations (BS)) that wirelessly communicate data, control information, reference signals, etc. (e.g., according to various wireless communication system implementations). Devices and network entities operating in a wireless communication system may employ various technologies to improve throughput, achieve a high data rate, and/or improve the energy efficiency of the wireless communication system. These technologies may allow a wireless communication system to support communication between an increasing number of devices and network entities, support advanced functionalities at various devices, improve the quality of communication between devices and network entities, etc.

As an example of the technologies for supporting communication between the increasing number of devices and network entities, a network entity may employ multiple access schemes to multiplex communications for multiple devices. For example, the multiple access schemes may include frequency-division multiple access (FDMA), orthogonal FDMA (OFDMA), single-carrier FDMA (SC-FDMA), time-division multiple access (TDMA), code-division multiple access (CDMA), orthogonal multiple access (OMA), nonorthogonal multiple access (NOMA), etc. In some cases, the multiple access schemes may increase capacity for a wireless communication system. That is, the multiple access schemes may enable communications with multiple devices on a set of time-frequency resources. For example, a network entity may multiplex communications for multiple devices on a same set of time-frequency resources using the multiple access schemes.

However, multiplexing communications for multiple devices on the same set of time-frequency resources may cause interference at the network entity. For example, communications from a first device on a set of time-frequency resources may interfere with communications from a second device on the set of time-frequency resources (e.g., non-orthogonal multiple access (NOMA) transmissions). Additionally or alternatively, the network entity may be unable to decipher which communications come from which device on the set of time-frequency resources.

Accordingly, the network entity may use and/or indicate for the devices to employ one or more techniques to mitigate the interference. For example, as described herein, the devices may use OCCs to mitigate the interference. Using an OCC, the devices may apply a cover code to data and/or messages sent to the network entity across a number of repetitions (e.g., transport block (TB) processing over multi-slot (TBoMS) physical uplink shared channels (PUSCHs)) in an orthogonal manner (e.g., communications from multiple devices may occupy same frequency bands and time slots after getting mapped on orthogonal spreading sequences or codes and/or discrete Fourier transforms (DFTs)).

In some aspects, uplink transmissions (e.g., using repetitions and/or TBoMS) may be sent with OCC (e.g., OCC encoding), which may result in less computational resources at the devices, reduced losses, and/or other advantages (e.g., compared to other encoding techniques or multiple access schemes, such as CDMA). Additionally, an orthogonal frequency-division multiplexing (OFDM) grid structure (e.g., for the multiple access schemes) may include different types of resource allocations that, when used with TBoMS, may enable using OCCs with different configurations. For example, the different configurations of OCC may include frequency domain OCC (FD-OCC), frequency domain combination (FD-comb), time domain OCC (TD-OCC) (e.g., TD-OCC for a symbol (TD-OCC-symbol) or TDD-OCC for a slot (TD-OCC-slot)), etc. Additionally, OCCs may be used across OFDM symbols, across slots, and/or within an OFDM symbol.

In some aspects, devices may use OCCs for PUSCH transmissions. PUSCH transmission with OCC may allow for PUSCH transmissions with repetition without sacrificing resource efficiency (e.g., due to the repetition). For example, multiple devices may send respective PUSCH transmissions on one or more same time-frequency resources with OCC (e.g., reducing the number of time-frequency resources that are used for communications). Additionally, each device may achieve coverage enhancement from the repetitions of the PUSCH transmissions (e.g., enhance or increase a reliability that the PUSCH transmissions are successfully communicated).

One or more technical problems arise for implementing OCCs. For example, to enable PUSCH transmissions with OCC, a mechanism is needed to indicate parameters for PUSCH with OCC to the devices (e.g., in a downlink control information (DCI) message, which is carried in a physical downlink control channel (PDCCH)) without increasing signaling overhead (e.g., increasing an amount of signaling and/or increasing resource usage). For example, for an OCC scheme to work, the devices may need to be notified about one or more OCC parameters. In some aspects, the one or more OCC parameters may include an OCC factor (M) and an OCC codeword (CW), where for each OCC factor, there are M possible OCC codewords. In some aspects, the OCC codeword may may refer to, include, or otherwise be referred to as an OCC sequence (e.g., sequence of values for the OCC codeword). The OCC factor may be semi-statically configured (e.g., using radio resource control (RRC) signaling) or dynamically configured (e.g., using DCI). Additionally, the devices may need to be informed (e.g., in DCI) about what codeword to use for a given OCC factor (e.g., the given OCC factor may correspond to a number of devices configured to communicate using OCC at a given time). In some aspects, dynamic switching between PUSCH transmission with OCC and without OCC may be desirable.

The techniques and signaling described herein provide a technical solution for a network entity indicating parameters for PUSCH with OCC to the devices. For example, as described herein, the network entity may signal the OCC parameters to the devices (e.g., for sending an uplink message, such as a PUSCH message) in DCI (e.g., downlink message) via an antenna port field (e.g., antenna port mapping field) included in the DCI. In some aspects, the antenna port field may include a number of bits (e.g., one bit, two bits, three bits, four bits, five bits, etc.), and the number of bits may correspond to an index value of a table, where the index value indicates a row of the table that includes respective OCC parameters. That is, the network entity may indicate a PUSCH transmission for a device by pointing to a logical transmit antenna port (e.g., corresponding to the antenna port field) in uplink scheduling DCI (e.g., DCI scheduling the PUSCH transmission), and the logical transmit antenna port may be mapped to certain OCC parameters for the device. In some aspects, the logical transmit antenna port may correspond to a demodulation reference signal (DMRS) port (e.g., virtual antenna port) of the device. While the techniques and signaling described herein are discussed with reference to tables, examples are not limited thereto (e.g., databases, hashes, and/or other structured data formats may be used to indicate respective OCC parameters).

In some aspects, tables that include respective OCC parameters may be pre-defined (e.g., defined in wireless standards). Additionally or alternatively, the tables that include respective OCC parameters may be configured (or updated) and signaled by the network entity (e.g., via RRC signaling). In some aspects, the network entity may indicate whether the device is to apply OCC or not based on an OCC indication (e.g., OCC flag) or another condition indicated in the DCI. Additionally or alternatively, the antenna port field may indicate an index value of the table that indicates for the device to not apply OCC. Subsequently, the device may send a PUSCH with applying an OCC (e.g., using the corresponding OCC parameters) or without applying an OCC.

The techniques for indicating OCC parameters via an antenna port field in DCI as described herein may provide any of various beneficial effects and/or advantages. For example, the network entity may reduce signaling overhead by repurposing the antenna port field to indicate the OCC parameters (e.g., rather than indicating the OCC parameters in a separate field and/or downlink message). Additionally, using OCC for sending a PUSCH may decrease interference from multiple devices attempting to send respective PUSCHs on one or more same time-frequency resources, which may increase reliability for communications from the multiple devices. Additionally, using OCC may increase resource efficiency for communications for the multiple devices (e.g., reduced channel usage, such as using fewer time-frequency resources).

### Introduction to Wireless Communications Networks

The techniques and methods described herein may be used for various wireless communications networks. While aspects may be described herein using terminology commonly associated with third generation (3G), fourth generation (4G), fifth generation (5G), sixth generation (6G), and/or other generations of wireless technologies, aspects of the present disclosure may likewise be applicable to other communications systems and standards not explicitly mentioned herein.

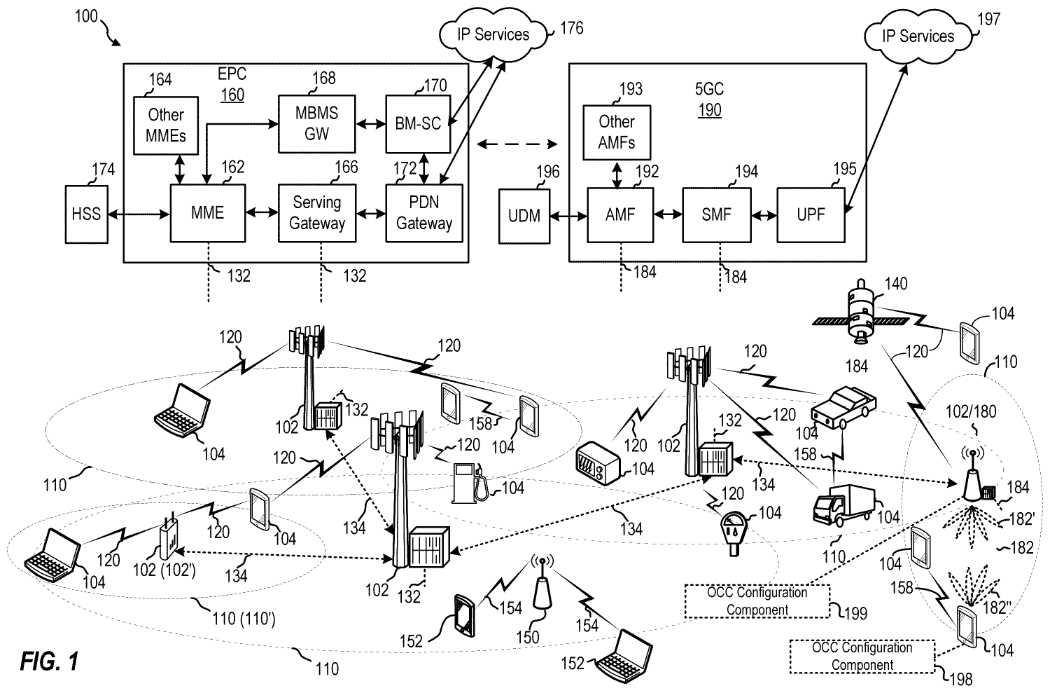

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point (AP), base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

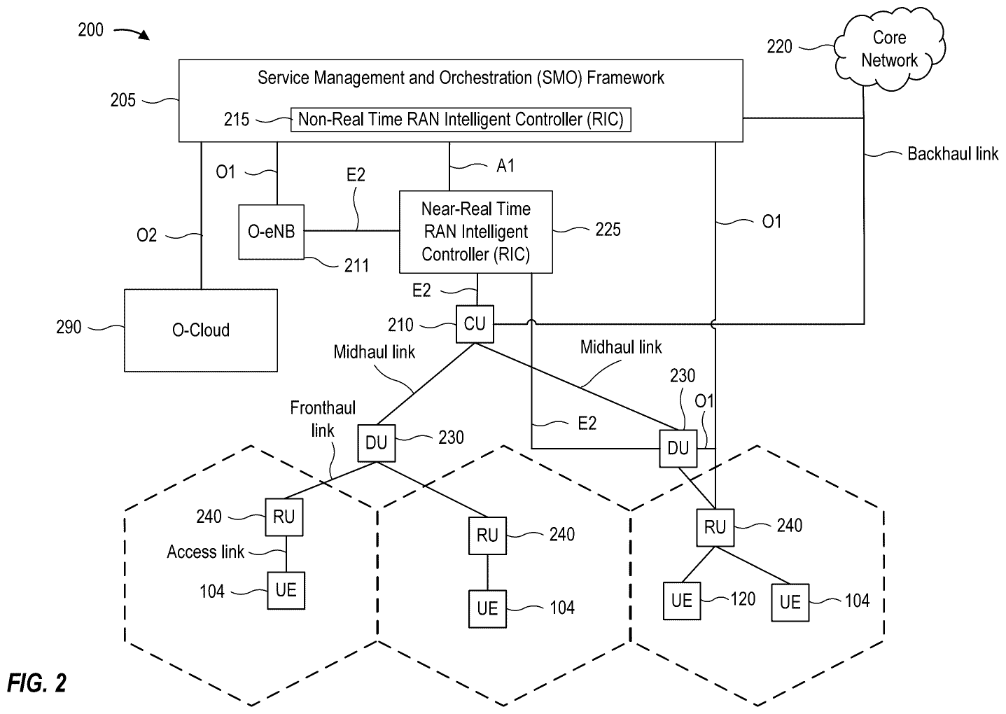

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G New Radio (NR) or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, Third Generation Partnership Project (3GPP) currently defines Frequency Range 1 (FR1) as including 410 megahertz (MHz)-7125 MHz, which is often referred to (interchangeably) as “Sub-6 gigahertz (GHz)”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

A UE 104 includes an OCC configuration component 198, which may be used to determine an OCC configuration based on an antenna port field and sending an uplink message using the OCC configuration as further described herein. Further, a BS 102 includes an OCC configuration component 199, which may be used to indicate an OCC configuration via an antenna port field for a UE 104 to send a corresponding uplink message using the OCC configuration as further described herein.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

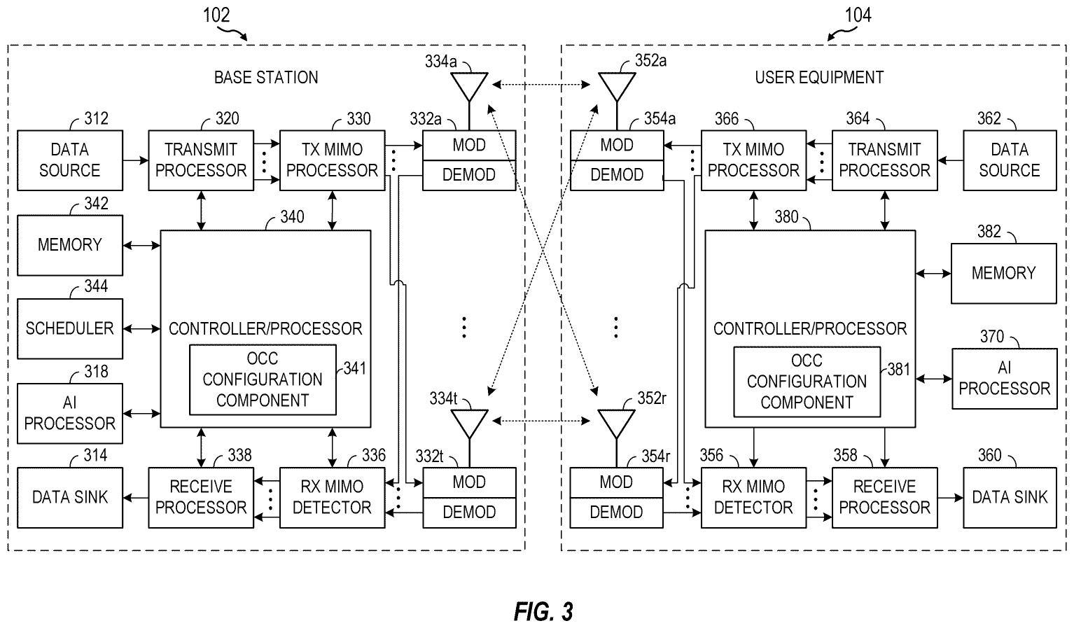

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

Receive (RX) MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for single-carrier frequency division multiplexing (SC-FDM)), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

In the depicted example, controller/processor 340 includes an OCC configuration component 341, which may be representative of the OCC configuration component 199 of FIG. 1. Notably, while depicted as an aspect of controller/processor 340, the OCC configuration component 341 may be implemented additionally or alternatively in various other aspects of a BS 102 in other implementations. Further, controller/processor 380 includes an OCC configuration component 381, which may be representative of the OCC configuration component 198 of FIG. 1. Notably, while depicted as an aspect of controller/processor 380, the OCC configuration component 381 may be implemented additionally or alternatively in various other aspects of a UE 104 in other implementations.

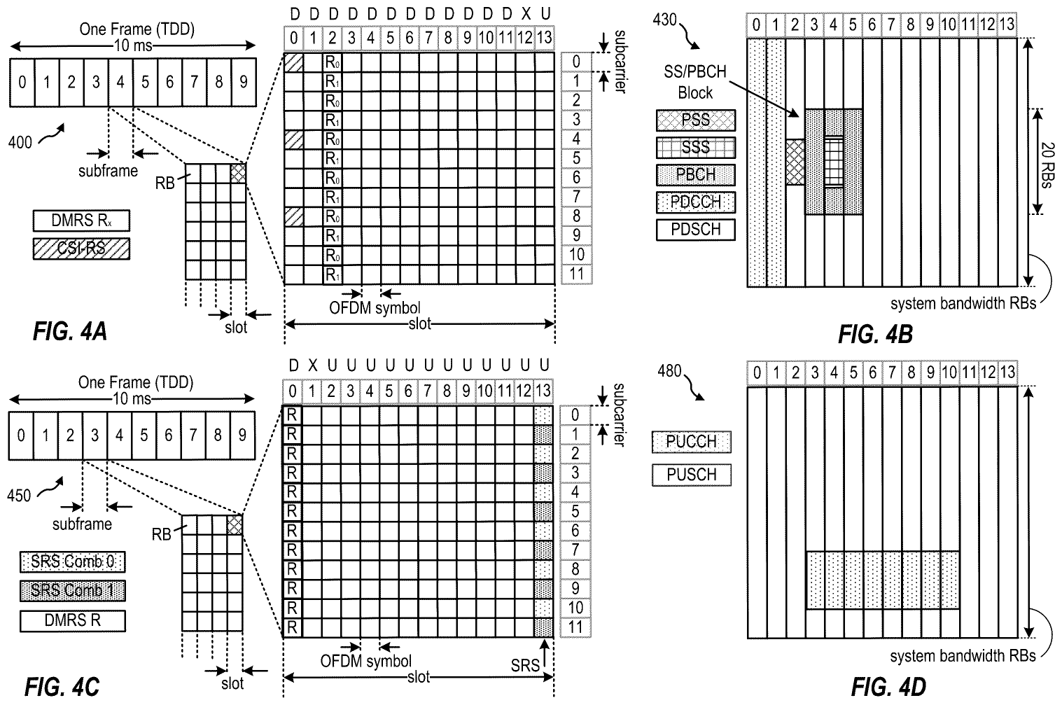

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and SC-FDM partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ acknowledgment (ACK)/negative acknowledgment (NACK) feedback. The PUSCH carries data, and may additionally be used to carry a buffer status report (BSR), a power headroom report (PHR), and/or UCI.

### Example Non-Terrestrial Network Communications

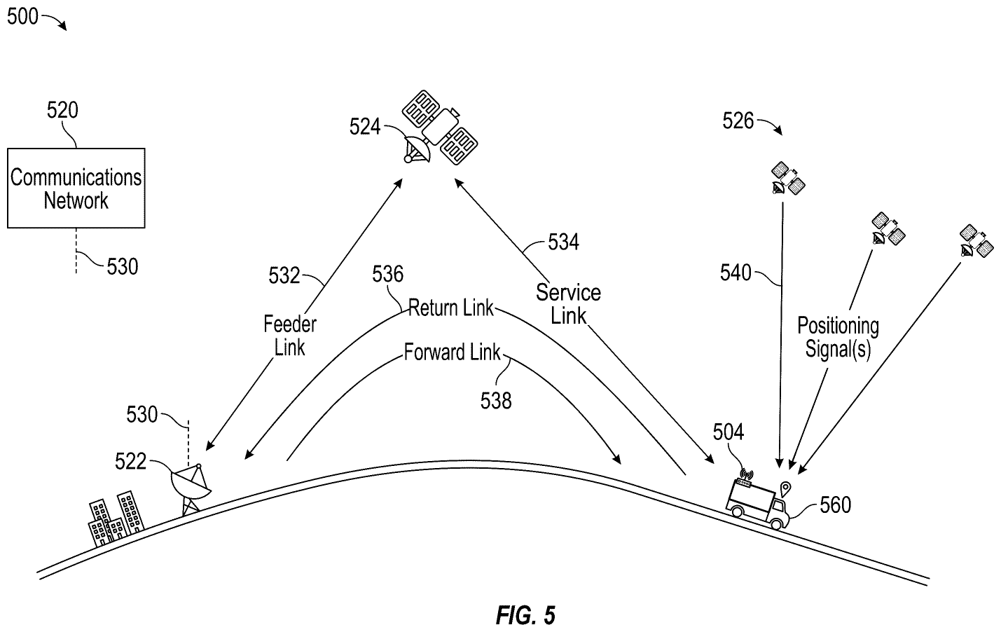

FIG. 5 depicts an example non-terrestrial network (NTN) 500. Certain wireless communication systems (e.g., Evolved Universal Terrestrial Radio Access (E-UTRA) systems, 5G NR systems, and/or future wireless communication systems) may facilitate communications coverage via an NTN, such as a spaceborne (e.g., satellite) or airborne (e.g., airship, balloon, etc.) platform that provides wireless connectivity to certain devices, such as UEs. In some cases, NTN communications may further facilitate communications with Narrowband Internet of Things (NB-IoT) devices, such as a sensor and/or identification tag attached to a vehicle (e.g., a delivery truck).

In this example, the NTN 500 includes a communications network 520 (e.g., the EPC 160 and/or the 5GC network 190 of FIG. 1), an NTN gateway 522, and an NTN payload 524. The NTN 500 may facilitate wireless communications with one or more UEs 504 (e.g., the UE 104 of FIG. 1). The UE 504 may include any of various types of UEs, such as an NB-IoT UE. As an example, the UE 504 may include an IoT sensor and/or identification tag affixed to a vehicle 560. The NTN 500 may allow the UE 504 to be in a coverage area for wireless communications even where the vehicle 560 travels great distances, for example, across one or more countries, or is stationed in certain locations lacking a terrestrial communications network. Note that the NB-IoT UE is an example, and other UEs may be capable of NTN communications.

The NTN gateway 522 may communicate with the communications network 520 via one or more interfaces 530, such as backhaul links including Next Generation (NG) interface(s) and/or S1 interface(s) between a RAN and a core network. The interface(s) 530 may include wired and/or wireless connections. The NTN gateway 522 may serve one or more NTN payloads 524 (e.g., network entities or NTN entities).

The NTN payload 524 may be or include one or more airborne platforms (e.g., a drone or balloon) and/or one or more spaceborne platforms (e.g., the satellite 140 as depicted in FIG. 1). The NTN payload 524 may be served by one or more NTN gateways 522. In certain aspects, the NTN payload 524 may include any of various non-terrestrial network entities and/or platforms that provide radio access through Geosynchronous orbits (GSO), Non-Geosynchronous Orbit (NGSO), which includes Low-Earth Orbit (LEO) and Medium Earth Orbit (MEO), or High Altitude Platform Systems (HAPS).

The NTN payload 524 may transparently forward communications (e.g., the radio protocol) received from the UE 504 (via a service link 534) to the NTN gateway 522 (via a feeder link 532), and/or vice-versa. The NTN gateway 522 and the NTN payload 524 may communicate via a wireless communication link referred to as the feeder link 532, and the NTN payload 524 may communicate with the UE 504 via a wireless communication link referred to as the service link 534. In some cases, the transparent links between the NTN gateway 522 and the UE 504 may be referred to as a return link 536 for communications from the UE 504 to the NTN gateway 522 and as a forward link 538 for communications from the NTN gateway 522 to the UE 504. In certain aspects, for communications from the NTN gateway 522, the NTN payload 524 may change the carrier frequency used on the feeder link 532, before re-transmitting the communications on the service link 534, and/or vice versa (respectively on the feeder link).

The service link 534 may include an Earth-fixed service link, a quasi-Earth-fixed service link, and/or an Earth-moving service link. An Earth-fixed service link may be implemented by beam(s) continuously covering the same geographical area(s) all the time (e.g., the case of GSO satellites). A quasi-Earth-fixed service link may be provisioned by beam(s) covering one geographic area for a limited period and a different geographic area during another period (e.g., the case of NGSO satellites generating steerable beams). An Earth-moving service link may be provisioned by beam(s) with a coverage area that slides over the Earth surface (e.g., the case of NGSO satellites generating fixed or non-steerable beams).

In certain aspects, the UE 504 may be in communication with a global navigation satellite system (GNSS) 526. For example, the UE 504 may receive positioning signal(s) 540 from the GNSS 526, and the positioning signal(s) 540 may provide certain information for synchronizing (e.g., time and/or frequency synchronization) the service link 534. The UE 504 may obtain the location of the NTN payload 524 via system information from the NTN payload 524. The UE 504 may estimate a timing delay and Doppler effects associated with the service link 534 using the positioning signal(s) 540 and the location of the NTN payload 524.

Technical problems for NTN communications include, for example, a UE 504 and an NTN payload 524 each including a single antenna for communications. For example, as described herein, the single antenna for the UE 504 and the NTN payload 524 may not support or enable MIMO antenna technology as described previously. However, without the need to support MIMO antenna technology, signaling that would otherwise be used to enable MIMO communications may be repurposed for other purposes.

### Aspects Related to Indicating OCC Configurations Via Antenna Port Indication

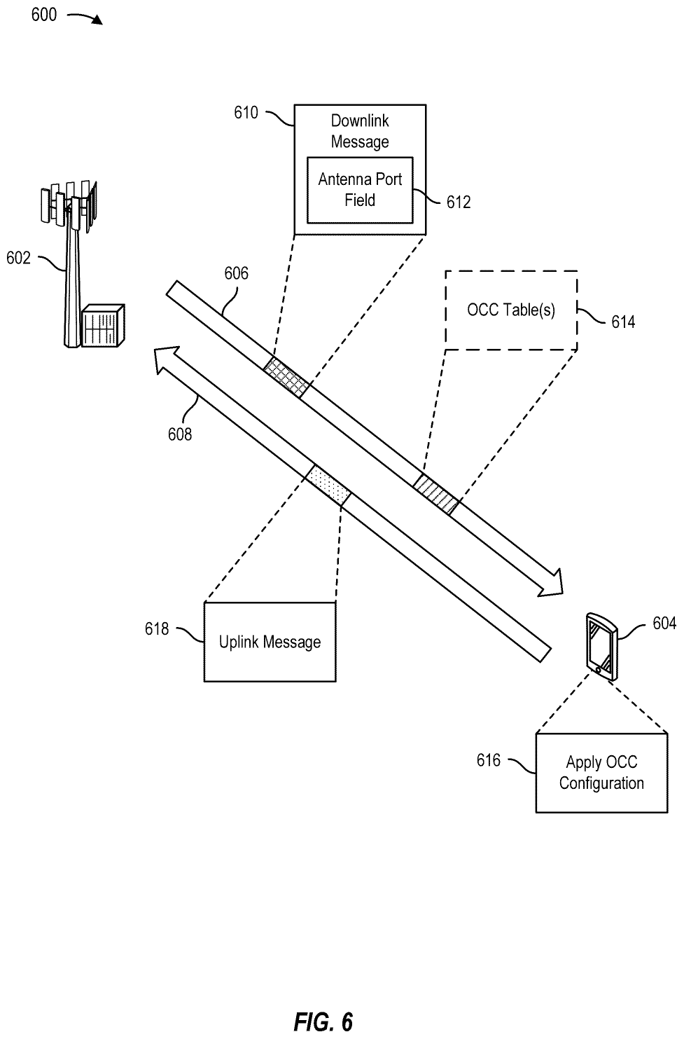

FIG. 6 depicts an example wireless communications network 600 that supports indicating OCC configurations via an antenna port indication (e.g., DMRS port indication) in accordance with aspects of the present disclosure. In some examples, the wireless communications network 600 may implement aspects of or may be implemented by aspects of FIGS. 1-5. For example, the wireless communications network 600 may include a network entity 602 and at least one device 604, where the network entity 602 represents a base station or similar network entity as described with reference to FIGS. 1-3 and 5 (e.g., BS 102, BS 180, satellite 140, NTN payload 524, etc.) and the device 10 604 represents a UE or similar terminal device as described with reference to FIGS. 1-3 and 5 (e.g., UE 104, UE 504, etc.). Additionally, the wireless communications network 600 may be an example of the wireless communications network 100 and may support communication between the network entity 602 and the device 604. For example, the network entity 602 and the device 604 may wirelessly communicate via a downlink communication link 606 (e.g., one or more carriers, a communication link 120, beamforming 182, etc.) and via an uplink communications link 608 (e.g., one or more carriers, a communications link 120, beamforming 182, etc.). While only one device 604 is depicted in the example of FIG. 6, the network entity 602 may communicate with multiple UEs.

As described herein and shown in the example of FIG. 6, the device 604 receives a downlink message 610 (e.g., from the network entity 602, such as via the downlink communication link 606), where the downlink message 610 includes an antenna port field 612. Subsequently, the antenna port field 612 may correspond to an index value of a table, and the index value may correspond to a row in the table, where the row includes an OCC configuration for the device 604 to apply for sending one or more uplink messages (e.g., to the network entity 602, such as via the uplink communication link 608).

As described previously, the OCC configuration may mitigate interference at the network entity 602 when multiple devices are sending uplink messages to the network entity 602 using one or more same time-frequency resources (e.g., for reduced channel usage). Each device of the multiple devices may use a different OCC codeword corresponding to a respective indicated OCC configuration, such that the network entity 602 may discern which uplink message is sent from which device of the multiple devices based on the different OCC codewords. Accordingly, the techniques and signaling described with reference to FIG. 6 may represent a PUSCH capacity enhancement with OCC (e.g., DFT spread OFDM (DFT-s-OFDM) PUSCH enhancement via OCC). For example, a higher amount of signaling may be achieved on PUSCH transmissions (e.g., from multiple devices) by using OCC.

In some aspects, the downlink message 610 may be a DCI message (e.g., DCI format 0_1), which is carried in a PDCCH. Additionally, the antenna port field 612 may include a DMRS port indication (e.g., antenna port indication) via the DCI message. For example, bits may be assigned in the DCI message for scheduling an uplink PUSCH for antenna ports (e.g., DMRS ports) of the device 604. As an example, in DCI format 0_1, there may be up to four bits allocated for this antenna port mapping. In some aspects, the antenna ports mapped by the bits may be logical transmit antenna ports of the device 604 (e.g., not physical antennas of the device 604). Additionally, as described herein, different logical transmit antenna ports may indicate that different DMRSs are transmitted for each value of the logical transmit antenna ports. In some aspects, a first DMRS transmitted (e.g., by the device 604) on a first logical transmit antenna port may be orthogonal to additional DMRSs transmitted on additional logical transmit antenna ports.

In some cases, these antenna ports may be useful when there is communication happening using multi-user (MU)-MIMO systems (e.g., multiple users or terminals, each radioing over one or more antennas, communicating with one another). However, for scenarios where MU-MIMO communication is not possible (e.g., single antenna NTN systems, such as the NTN 500 as described with reference to FIG. 5), using orthogonal DMRS for single user communications may not be desirable. For example, the network entity 602 and the device 604 (e.g., and additional devices not illustrated in the example of FIG. 6) may each include a single antenna, such that MU-MIMO is not employed in the wireless communications network 600. Tables 1 and 2 are provided below and include currently defined DMRS port mappings in the DCI message.

TABLE 1
DMRS Port Mapping in DCI with maxlength = 1

| | Number of DMRS Code- | | |
|---|---|---|---|
| | Division Multiplexing (CDM) | DMRS | Number of Front- |
| Value | Group(s) without Data | Port(s) | Load Symbols |
| 0 | 2 | 0 | 1 |
| 1 | 2 | 1 | 1 |
| 2 | 2 | 2 | 1 |
| 3 | 2 | 3 | 1 |

TABLE 2
DMRS Port Mapping in DCI with maxlength = 2

| | Number of DMRS CDM | DMRS | Number of Front- |
|---|---|---|---|
| Value | Group(s) without Data | Port(s) | Load Symbols |
| 0 | 2 | 0 | 1 |
| 1 | 2 | 1 | 1 |
| 2 | 2 | 2 | 1 |
| 3 | 2 | 3 | 1 |
| 4 | 2 | 0 | 2 |
| 5 | 2 | 1 | 2 |
| 6 | 2 | 2 | 2 |
| 7 | 2 | 3 | 2 |
| 8 | 2 | 4 | 2 |
| 9 | 2 | 5 | 2 |
| 10 | 2 | 6 | 2 |
| 11 | 2 | 7 | 2 |
| 12-15 | Reserved | Reserved | Reserved |

Tables 1 and 2 may include different DMRS port mappings for different maxlength values (e.g., a number of symbols or other time resources to be used for DMRS transmissions from the device 604). For example, in Table 1, the DMRS port mappings are defined for a maxlength of 1 (e.g., the device 604 is configured to transmit a DMRS using one symbol). Subsequently, for Table 1, two bits may be needed in the DCImessage to capture the four entries (e.g., ‘00’ corresponds to the value ‘0’ row of Table 1, ‘01’ corresponds to the value ‘1’ of Table 1, ‘10’ corresponds to the value ‘2’ of Table 1, and ‘11’ corresponds to the value ‘3’ of Table 1). Additionally or alternatively, in Table 2, the DMRS port mappings are defined for a maxlength of 2 (e.g., the device 604 is configured to transmit a DMRS using two symbols). Subsequently, four bits may be needed in the DCI message to capture the 16 entries (e.g., ‘0000’ corresponds to the value ‘0’ row of Table 2, ‘0001’ corresponds to the value ‘1’ of Table 2, ‘0010’ corresponds to the value ‘2’ of Table 2, ‘0011’ corresponds to the value ‘3’ of Table 2, etc., up to ‘1111’ corresponds to the value ‘16’ row of Table 2).

Accordingly, as described herein, when the DMRS port mappings are undesirable (e.g., where MU-MIMO communication is not possible, such as in single antenna systems or single antenna NTN systems), the bits assigned to the antenna port mapping (e.g., DMRS port mapping) in the DCI may be used to indicate an OCC configuration (e.g., one or more OCC parameters) for the device 604. That is, the network entity 602 may indicate the OCC configuration to the device 604 via the antenna port field 612 (e.g., a DMRS port indication) in the DCI (e.g., the downlink message 610). For example, the network entity 602 may indicate a PUSCH transmission for the device 604 to send by pointing to a logical transmit antenna port (e.g., DMRS port) in the DCI that schedules the PUSCH transmission (e.g., scheduling DCI), and the logical transmit antenna port may be mapped to the OCC configuration (e.g., certain OCC parameters). As described herein, the OCC configuration may at least include an OCC factor (e.g., M as described previously, which may also be referred to as a spreading factor) and an OCC codeword index (e.g., index value corresponding to a CW) or an OCC sequence (e.g., sequence of values for the CW itself). In some aspects, the OCC factor may correspond to a number of devices configured to communicate using OCC at a given time. In some aspects, the OCC codeword index may refer to, include, or otherwise be referred to as an OCC sequence and/or an OCC sequence index (e.g., the OCC sequence itself and/or an index value corresponding to an OCC sequence for a CW). Additionally, the techniques and signaling described with reference to FIG. 6 may represent an uplink capacity and/or throughput enhancement for FR1 in NTN systems, but the techniques and signaling may also be used for other wireless communication systems.

In some aspects, the antenna port field 612 (e.g., the logical transmit antenna ports) may be mapped to rows of tables that are predefined, where the rows in the predefined tables include respective OCC configurations. For example, the predefined tables may be defined in wireless standards, where the predefined tables may be configured and stored in a memory of the device 604. Accordingly, upon receiving the downlink message 610 that includes an indication of the antenna port field 612, the device 604 may reference the predefined tables to determine the corresponding OCC configuration. In some aspects, the mapping of the logical transmit antenna ports to corresponding OCC configurations may be configurable by the network entity 602.

Additionally or alternatively, the network entity 602 may generate (e.g., configure) one or more OCC tables 614 and may send the one or more OCC tables 614 to the device 604 (e.g., via the downlink communication link 606). For example, the network entity 602 may send the one or more OCC tables 614 via RRC signaling. In some aspects, the RRC signaling may include information about the one or more OCC tables 614, such as via an information element (IE) (e.g., a PUSCH configuration IE (PUSCH-Config IE)). Within the IE, another IE may include the one or more OCC tables 614, and/or DMRS-related IEs may include the one or more OCC tables 614. For generation of the one or more OCC tables 614, the network entity 602 may configure each value in the one or more OCC tables 614 (e.g., each value in each column of the one or more OCC tables 614).

Subsequently, after receiving the one or more OCC tables 614, the device 604 (e.g., and additional devices) may receive the downlink message 610 (e.g., DCI) including the antenna port field 612 (e.g., logical transmit antenna port indication, DMRS port indication, etc.) and may follow the mapping provided in the one or more OCC tables 614 to determine an OCC configuration for sending one or more uplink messages. Additionally, the mapping of the antenna port field 612 to corresponding OCC configurations may be configurable by the network entity 602.

In some aspects, entries in tables (e.g., the predefined tables or the one or more OCC tables 614 that are dynamically generated) may include both OCC configurations (e.g., indicating for the device 604 to use OCC) and non-OCC configurations (e.g., indicating for the device 604 to not use OCC). For example, Tables 3 and 4 provided below are examples of tables with both OCC configurations and non-OCC configurations that are indicated for the device 604 to use according to the antenna port field 612 in the downlink message 610. In some aspects, Tables 3 and 4 may be derived from Tables 1 and 2 (e.g., Tables 3 and 4 include the same information as Tables 1 and 2 but with an OCC factor and an OCC codeword index (or OCC sequence) indicated for each row). Additionally, Tables 3 and 4 may be predefined or dynamically generated as described previously.

TABLE 3
OCC and non-OCC Configurations for maxlength = 1

| | Number of DMRS | | Number of | | |
|---|---|---|---|---|---|
| | CDM Group(s) | DMRS | Front-Load | OCC | |
| Value | without Data | Port(s) | Symbols | Factor | CW Index |
| 0 | 2 | 0 | 1 | 2 | 0 |
| 1 | 2 | 1 | 1 | 2 | 1 |
| 2 | 2 | 0 | 1 | 4 | 0 |
| 3 | 2 | 1 | 1 | 4 | 1 |
| 4 | 2 | 2 | 1 | 4 | 2 |
| 5 | 2 | 3 | 1 | 4 | 3 |
| 6 | 2 | 0 | 1 | 1 | 0 |
| 7 | X | X | X | X | X |

TABLE 4
OCC and non-OCC Configurations for maxlength = 2

| | Number of DMRS | | Number of | | |
|---|---|---|---|---|---|
| | CDM Group(s) | DMRS | Front-Load | OCC | |
| Value | without Data | Port(s) | Symbols | Factor | CW Index |
| 0 | 2 | 0 | 1 | 2 | 0 |
| 1 | 2 | 1 | 1 | 2 | 1 |
| 2 | 2 | 0 | 1 | 4 | 0 |
| 3 | 2 | 1 | 1 | 4 | 1 |
| 4 | 2 | 2 | 1 | 4 | 2 |
| 5 | 2 | 3 | 1 | 4 | 3 |
| 6 | 2 | 0 | 2 | 8 | 0 |
| 7 | 2 | 1 | 2 | 8 | 1 |
| 8 | 2 | 2 | 2 | 8 | 2 |
| 9 | 2 | 3 | 2 | 8 | 3 |
| 10 | 2 | 4 | 2 | 8 | 4 |
| 11 | 2 | 5 | 2 | 8 | 5 |
| 12 | 2 | 6 | 2 | 8 | 6 |
| 13 | 2 | 7 | 2 | 8 | 7 |
| 14 | 2 | 0 | 1 | 1 | 0 |
| 15 | X | X | X | X | X |

As shown in Tables 3 and 4, the different values for the antenna port field 612 (e.g., the left-most column) may correspond to respective OCC configurations (e.g., respective OCC factors and OCC codeword indexes or OCC sequences). For Table 3 (e.g., where maxlength is 1 as described previously), three bits are needed in the downlink message 610 for the antenna port field 612 to capture the eight respective entries of the table. For example, ‘000’ may correspond to the value ‘0’ for the antenna port field 612 with an OCC configuration that includes an OCC factor of ‘2’ and an OCC codeword index of ‘0,’ ‘011’ may correspond to a value of ‘3’ for the antenna port field 612 with an OCC configuration that includes an OCC factor of ‘4’ and an OCC codeword index of ‘1,’ ‘101’ may correspond to a value of ‘5’ for the antenna port field 612 with an OCC configuration that includes an OCC factor of ‘4’ and an OCC codeword index of ‘3,’ etc.

Additionally, with the example of Table 3, uplink messages for up to four devices may be multiplexed using respective OCC configurations. For example, the values ‘2’ to ‘5’ for the antenna port field 612 (e.g., corresponding to an OCC factor of ‘4’) may be used if uplink messages from three or four devices are intended to be multiplexed together. Additionally or alternatively, if uplink messages from two devices are intended to be multiplexed together, the values of ‘0’ and ‘1’ for the antenna port field 612 (e.g., corresponding to an OCC factor of ‘2’) may be used. In some aspects, the network entity 602 may still use the values of ‘2,’ ‘3,’ ‘4,’ or ‘5’ for the antenna port field 612 even if uplink messages from two devices are intended to be multiplexed together (e.g., up to network implementation).

Additionally or alternatively, for Table 4 (e.g., where maxlength is 2 as described previously), four bits are needed in the downlink message 610 for the antenna port field 612 to capture the 16 respective entries of the table. For example, ‘0000’ may correspond to the value ‘0’ for the antenna port field 612 with an OCC configuration that includes an OCC factor of ‘2’ and an OCC codeword index of ‘0,’ ‘0011’ may correspond to a value of ‘3’ for the antenna port field 612 with an OCC configuration that includes an OCC factor of ‘4’ and an OCC codeword index of ‘1,’ ‘1001’ may correspond to a value of ‘9’ for the antenna port field 612 with an OCC configuration that includes an OCC factor of ‘8’ and an OCC codeword index of ‘3,’ etc.

Additionally, with the example of Table 4, uplink message for up to eight devices may be multiplexed using respective OCC configurations. For example, values ‘6’ to ‘13’ for the antenna port field 612 (e.g., corresponding to an OCC factor of ‘8’) may be used if uplink messages from five to eight devices are intended to be multiplexed together. As described previously with reference to Table 3, values ‘2’ to ‘5’ may be used for the antenna port field 612 (e.g., corresponding to an OCC factor of ‘4’) if uplink messages from three or four devices are intended to be multiplexed together, and values ‘0’ and ‘1’ may be used for the antenna port field 612 (e.g., corresponding to an OCC factor of ‘4’) if uplink messages from two devices are intended to be multiplexed together. Additionally or alternatively, values ‘6’ to ‘13’ for the antenna port field 612 may be used if uplink messages from less than five devices are intended to be multiplexed together (e.g., up to network implementation).

As can be seen in both Tables 3 and 4, a value may be defined for the antenna port field 612 that indicates for the device to not use OCC for sending an uplink message. For example, in Table 3, value ‘6’ for the antenna port field 612 (e.g., corresponding to bits ‘110’) may indicate for the device to not use OCC according to the corresponding OCC factor of ‘1’ (e.g., and OCC codeword index of ‘0’), and in Table 4, value ‘14’ for the antenna port field 612 (e.g., corresponding to bits ‘1110’) may indicate for the device to not use OCC according to the corresponding OCC factor of ‘1’ (e.g., and OCC codeword index of ‘0’).

In some aspects, using Tables 3 and 4, the network entity 602 may indicate an OCC factor to the device 604 (e.g., and additional devices). Additionally or alternatively, the network entity 602 may semi-statically configure the OCC factor beforehand to the device 604 and/or additional devices (e.g., via RRC signaling), and the network entity 602 may indicate an OCC codeword index for the configured OCC factor to the device 604 (e.g., which may reduce a number of bits needed to indicate the OCC configuration) and/or the additional devices via the antenna port field 612 of the downlink message 610. That is, an indication of the OCC configuration based on the antenna port field 612 (e.g., including the OCC codeword index) may depend on the OCC factor and/or a maximum OCC factor if the OCC factor is separately configured.

For example, the network entity 602 may configure the maximum OCC factor (e.g., via RRC signaling and/or via a DCI), and a table indicating OCC configurations that correspond to different values for the antenna port field 612 may include OCC configurations up to that maximum OCC factor. As an example, if the network entity 602 configures a maximum OCC factor of four, the table indicating OCC configurations that correspond to different values for the antenna port field 612 may correspond to Table 3 provided previously. Additionally or alternatively, if the network entity 602 configures a maximum OCC factor of two, the table indicating OCC configurations that correspond to different values for the antenna port field 612 may correspond to Table 5 provided below. In some aspects, Table 5 may be predefined or dynamically generated as described previously.

TABLE 5
OCC and Non-OCC Configurations
for a Maximum OCC Factor = 2

| | Number of DMRS | | Number of | | |
|---|---|---|---|---|---|
| | CDM Group(s) | DMRS | Front-Load | OCC | |
| Value | without Data | Port(s) | Symbols | Factor | CW Index |
| 0 | 2 | 0 | 1 | 2 | 0 |
| 1 | 2 | 1 | 1 | 2 | 1 |
| 2 | 2 | 2 | 1 | 2 | 0 |
| 3 | 2 | 3 | 1 | 2 | 1 |
| 4 | 2 | 2 | 1 | 1 | 0 |
| 5 | 2 | 3 | 1 | 1 | 0 |
| 6 | 2 | 0 | 1 | 1 | 0 |
| 7 | X | X | X | X | X |

In some aspects, rather than configuring a maximum OCC factor, the network entity 602 may configure and indicate an actual OCC factor to the device 604 and/or the additional devices. For example, the network entity 602 may indicate the OCC factor via RRC signaling (e.g., semi-statically) or a DCI message (e.g., dynamically). Tables 6 and 7 provided below may illustrate tables with OCC configurations that are indicated for the device 604 (e.g., and/or the additional devices) to use according to the antenna port field 612 in the downlink message 610. In some aspects, Tables 6 and 7 may be predefined or dynamically generated as described previously. In the example of Table 6, the network entity 602 may indicate an actual OCC factor of four, and in the example of Table 7, the network entity 602 may indicate an actual OCC factor of two.

TABLE 6
OCC Configurations for an OCC Factor = 4

| | Number of DMRS | | Number of | | |
|---|---|---|---|---|---|
| | CDM Group(s) | DMRS | Front-Load | OCC | |
| Value | without Data | Port(s) | Symbols | Factor | CW Index |
| 0 | 2 | 0 | 1 | 4 | 0 |
| 1 | 2 | 1 | 1 | 4 | 1 |
| 2 | 2 | 2 | 1 | 4 | 2 |
| 3 | 2 | 3 | 1 | 4 | 3 |
| 4 | 2 | 2 | 1 | 4 | 0 |
| 5 | 2 | 3 | 1 | 4 | 1 |
| 6 | 2 | 0 | 1 | 4 | 2 |
| 7 | 2 | 1 | 1 | 4 | 3 |

TABLE 7
OCC Configurations for an OCC Factor = 2

| | Number of DMRS | | Number of | | |
|---|---|---|---|---|---|
| | CDM Group(s) | DMRS | Front-Load | OCC | |
| Value | without Data | Port(s) | Symbols | Factor | CW Index |
| 0 | 2 | 0 | 1 | 2 | 0 |
| 1 | 2 | 1 | 1 | 2 | 1 |
| 2 | 2 | 2 | 1 | 2 | 0 |
| 3 | 2 | 3 | 1 | 2 | 1 |
| 4 | 2 | 2 | 1 | 2 | 0 |
| 5 | 2 | 3 | 1 | 2 | 1 |
| 6 | 2 | 0 | 1 | 2 | 0 |
| 7 | 2 | 1 | 1 | 2 | 1 |

In some aspects, rather than having values for the antenna port field 612 in tables that correspond to non-OCC configurations (e.g., where a corresponding OCC factor is ‘1’ for the respective values of the antenna port field 612 as shown in Tables 3, 4, and 5), the device 604 may determine whether to use OCC or to not use OCC for sending the one or more uplink messages based on an OCC flag (e.g., a single bit such as ‘0’ indicating not to use OCC and ‘1’ indicating to use OCC or vice versa) or another condition indicated in the downlink message 610. Accordingly, if the OCC flag indicates for the device to not use OCC, then the device 604 may determine to use one of Tables 1 and 2 for identifying parameters for sending one or more uplink messages. Additionally or alternatively, if the OCC flag indicates for the device to use OCC, then the device 604 may determine to use one of Tables 8 and 9 provided below for identifying an OCC configuration (e.g., corresponding to the antenna port field 612) for sending one or more uplink messages. In some aspects, Tables 8 and 9 may be predefined or dynamically generated as described previously.

TABLE 8
OCC Configurations for maxlength = 1

| | Number of DMRS | | Number of | | |
|---|---|---|---|---|---|
| | CDM Group(s) | DMRS | Front-Load | OCC | |
| Value | without Data | Port(s) | Symbols | Factor | CW Index |
| 0 | 2 | 0 | 1 | 2 | 0 |
| 1 | 2 | 1 | 1 | 2 | 1 |
| 2 | 2 | 0 | 1 | 4 | 0 |
| 3 | 2 | 1 | 1 | 4 | 1 |
| 4 | 2 | 2 | 1 | 4 | 2 |
| 5 | 2 | 3 | 1 | 4 | 3 |
| 6-7 | X | X | X | X | X |

TABLE 9
OCC Configurations for maxlength = 2

| | Number of DMRS | | Number of | | |
|---|---|---|---|---|---|
| | CDM Group(s) | DMRS | Front-Load | OCC | |
| Value | without Data | Port(s) | Symbols | Factor | CW Index |
| 0 | 2 | 0 | 1 | 2 | 0 |
| 1 | 2 | 1 | 1 | 2 | 1 |
| 2 | 2 | 0 | 1 | 4 | 0 |
| 3 | 2 | 1 | 1 | 4 | 1 |
| 4 | 2 | 2 | 1 | 4 | 2 |
| 5 | 2 | 3 | 1 | 4 | 3 |
| 6 | 2 | 0 | 2 | 8 | 0 |
| 7 | 2 | 1 | 2 | 8 | 1 |
| 8 | 2 | 2 | 2 | 8 | 2 |
| 9 | 2 | 3 | 2 | 8 | 3 |
| 10 | 2 | 4 | 2 | 8 | 4 |
| 11 | 2 | 5 | 2 | 8 | 5 |
| 12 | 2 | 6 | 2 | 8 | 6 |
| 13 | 2 | 7 | 2 | 8 | 7 |
| 14-15 | X | X | X | X | X |

In the examples of Tables 8 and 9, rather than having values for the antenna port field 612 in tables that correspond to non-OCC configurations (e.g., where a corresponding OCC factor is ‘1’ for the respective values of the antenna port field 612 as shown in Tables 3, 4, and 5), the OCC flag may be used to indicate whether the device 604 (e.g., and/or the additional devices) should use OCC or should not use OCC for sending the one or more uplink messages. Accordingly, Tables 8 and 9 may not include values for the antenna port field 612 that correspond to non-OCC configurations.

Additionally, as described previously, the network entity 602 may configure a maximum OCC factor (e.g., semi-statically, such as via RRC signaling or dynamically, such as via a DCI message) and/or an actual OCC factor (e.g., semi-statically, such as via RRC signaling, or dynamically, such as via a DCI message). Subsequently, the device 604 may determine a table to use for identifying an OCC configuration corresponding to the antenna port field 612 when the OCC flag is also used to indicate whether the device 604 should use OCC or should not use OCC for sending the one or more uplink messages (e.g., rather than including non-OCC configurations in a corresponding table).

For example, if the network entity 602 indicates for the device 604 (e.g., and/or the additional devices) to use OCC (e.g., via the OCC flag) and configures a maximum OCC factor of four, then the device 604 may use Table 8 as provided previously to identify an OCC configuration corresponding to the antenna port field 612. Additionally or alternatively, if the network entity 602 indicates for the device 604 (e.g., and/or the additional devices) to use OCC (e.g., via the OCC flag) and configures a maximum OCC factor of two, then the device 604 may use Table 10 provided below to identify an OCC configuration corresponding to the antenna port field 612. In some aspects, Table 10 may be predefined or dynamically constructed as described previously.

TABLE 10
OCC Configurations for a Maximum OCC Factor = 2

| | Number of DMRS | | Number of | | |
|---|---|---|---|---|---|
| | CDM Group(s) | DMRS | Front-Load | OCC | |
| Value | without Data | Port(s) | Symbols | Factor | CW Index |
| 0 | 2 | 0 | 1 | 2 | 0 |
| 1 | 2 | 1 | 1 | 2 | 1 |
| 2 | 2 | 2 | 1 | 2 | 0 |
| 3 | 2 | 3 | 1 | 2 | 1 |

Additionally or alternatively, if the network entity 602 indicates for the device 604 (e.g., and/or the additional devices) to use OCC (e.g., via the OCC flag) and configures an actual OCC factor of four, then the device 604 may use Table 6 as provided previously to identify an OCC configuration corresponding to the antenna port field 612. Additionally or alternatively, if the network entity 602 indicates for the device 604 (e.g., and/or the additional devices) to use OCC (e.g., via the OCC flag) and configures an actual OCC factor of two, then the device 604 may use Table 7 as provided previously to identify an OCC configuration corresponding to the antenna port field 612.

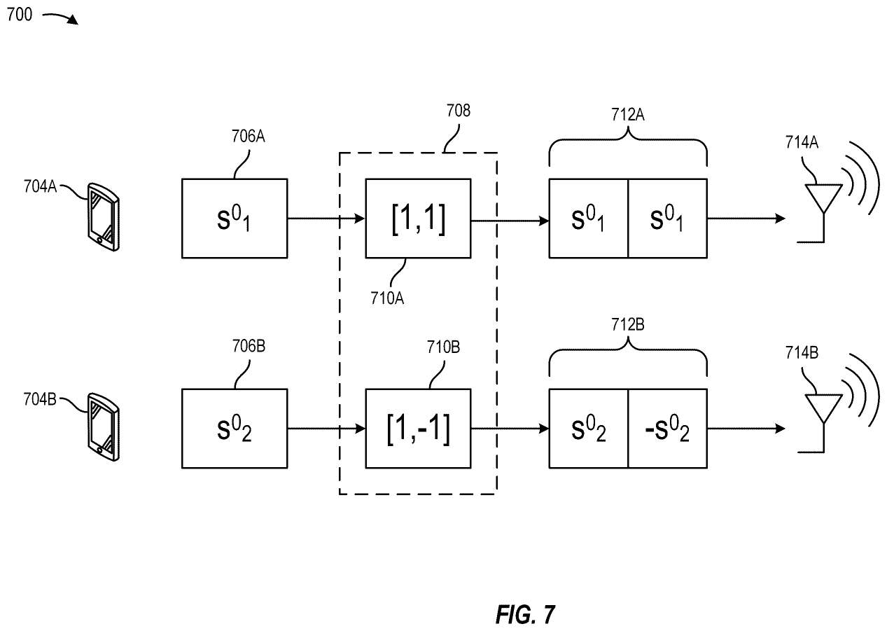

Accordingly, after the device 604 determines an OCC configuration to use according to the antenna port field 612 (e.g., from one of the tables provided previously), the device 604 may perform an operation 616 to apply the OCC configuration to an uplink message 618. In some aspects, the uplink message 618 may be a DMRS transmission or another uplink transmission sent via a PUSCH. The operation 616 of applying the OCC configuration is described in greater detail with reference to FIG. 7. Subsequently, the device 604 may send the uplink message 618 (e.g., to the network entity 602, such as via the uplink communication link 608) with the OCC configuration applied to the uplink message 618.

In some aspects, there may be additional flexibility on the sizes of the tables provided previously (e.g., equivalent to number of DCI bits) depending on, for example, network configuration. For example, for a given maximum OCC factor, the network entity 602 may choose to configure a two, three, four, or five bit table (e.g., which may depend on a level of flexibility the device 604 and/or the additional devices would need). In some aspects, the tables may include an OCC sequence instead of or in addition to the OCC codeword index. That is, rather than the OCC codeword index pointing to a corresponding OCC codeword, the tables may include the actual OCC codeword and/or OCC sequence (e.g., sequence of values for the OCC codeword) for each entry of the tables.

### Aspects Related to an OCC for Uplink Transmissions

FIG. 7 depicts an example operation 700 that supports applying an OCC for uplink transmissions in accordance with aspects of the present disclosure. In some examples, the operation 700 may implement aspects of or may be implemented by aspects of FIGS. 1-5. For example, a device (e.g., UE 104, UE 504, device 604, etc.) may be configured (e.g., via a BS 102, BS 180, satellite 140, NTN payload 524, network entity 602, etc.) to use an OCC configuration for sending one or more uplink transmissions based on an antenna port field received in a downlink message (e.g., a DCI carried in a PDCCH) as described with reference to FIG. 6. In the example of FIG. 7, a first device 704A and a second device 704B may be configured to use respective OCC configurations (e.g., based on respective antenna port fields). Additionally, the first device 704A and the second device 704B may include a single antenna (e.g., as well as a network entity that is communicating with the devices 704), such that MU-MIMO is not employed by either device 704.

In some aspects, OCC may represent a code division multiplexing scheme (e.g., applying M OCCs to a symbol group according to an OCC factor, M), where M codeword-based symbol groups (e.g., M-codeword-based signals having a length of a symbol group) may be able to share the same time-frequency resource (e.g., a same subcarrier in a same symbol group index). The codeword-based symbol groups may allow multiple devices to transmit on the same time-frequency resource(s), and thus, the number of devices that can send respective uplink messages at the same time on the time-frequency resource(s) for the respective uplink messages may be proportionally increased by the number of codewords used for OCC. Such an increase in for the number of devices that can send respective uplink messages on the same time-frequency resources may alleviate channel congestion as more devices are deployed in a network.

Without OCC, signals (e.g., uplink messages) sent by a plurality of devices on same time-frequency resources may be seen as one signal by a network entity. As such, it would be difficult for the network entity to separate device-specific signals from this one superimposed signal. However, with OCC enabled, the network entity may know that a particular device is sending its respective signaling (e.g., uplink message on a PUSCH) with a corresponding OCC codeword and OCC factor. Subsequently, the network entity may use this OCC information to extract the signaling sent by that particular device from the superimposed signal. Additionally, the network entity may then also do the same for each device to extract the signaling for each device from the superimposed signal (e.g., based on respective OCC codewords configured and/or indicated for each device).

The first device 704A may be scheduled to transmit a first uplink message 706A on a PUSCH, and the second device 704B may be scheduled to send a second uplink message 706B on the PUSCH. For example,

$${s}_{i}^{j}$$

may represent an uplink message (s) on a resource element (RE) j (e.g., time-frequency resource) for a device i. Accordingly, in the example of FIG. 7, the first uplink message 706A may be represented by

$${s}_{1}^{0}$$

to indicate a RE ‘0’ of the PUSCH for the first device 704A (e.g., device ‘1’), and the second uplink message 706B may be represented by

$${s}_{2}^{0}$$

to indicate the RE ‘0’ of the PUSCH for the second device 704B (e.g., device ‘2’).

Subsequently, the first device 704A and the second device 704B may perform an operation 708 to apply respective OCCs to each uplink message 706 to enable both devices to transmit on the same time-frequency resource(s) of the PUSCH (e.g., RE ‘0’) and allow the network entity to identify the respective uplink messages 706. In the example of FIG. 7, the OCC configurations applied by each device 704 may include an OCC factor of two (e.g., M=2). As described previously with reference to FIG. 6, the devices 704 may be configured with the OCC factor of two based on an antenna port field (e.g., logical transmit antenna port indication, DMRS port indication, etc.) received in a downlink message (e.g., DCI message). Additionally or alternatively, the devices 704 may be configured with the OCC factor (e.g., maximum OCC factor or actual OCC factor) prior to receiving the downlink message.

As part of the operation 708, the first device 704A may apply a first OCC codeword 710A to the first uplink message 706A, and the second device 704B may apply a second OCC codeword 710B to the second uplink message 706B. In some aspects, the devices 704 may apply the respective OCC codewords 710 to the uplink messages 706 after channel encoding (e.g., turbo coding or another type of encoding) and symbol modulation. For example, the devices 704 may have a set of information bits to transmit in each uplink message 706, where the information bits are channel coded into coded bits (e.g., including cyclic redundancy check (CRC) bits and other bits). Subsequently, these coded bits may then be modulated inot symbols using a modulation scheme (e.g., binary phase shift keying (BPSK), quadrature phase shift keying (QPSK), 16-quadrature amplitude modulation (QAM), etc.). These modulated symbols may then be mapped to REs, and the devices 704 may apply the OCC codewords 710 to the REs. In some aspects, the devices 704 may apply the OCC codewords 710 before modulation (e.g., when the modulation scheme is BPSK or QPSK), where the OCC codewords 710 are still applied after channel coding.

As described with reference to FIG. 6, the first device 704A and the second device 704B may identify the respective OCC codewords 710 based on the antenna port field received in the downlink message. For example, the antenna port field may correspond to an OCC codeword index (e.g., based on one of the tables as provided in the example of FIG. 6), where the OCC codeword index indicates the respective OCC codeword 710. In some aspects, the devices 704 may store a plurality of OCC codewords in respective memories of each device 704 and may identify which OCC codeword corresponds to the indicated OCC codeword indexes from the respective antenna port fields. To mitigate interference from each uplink message 706 on the PUSCH, each device 704 may be configured with a different OCC codeword 710. For example, the first OCC codeword 710A may be represented by [1,1], and the second OCC codeword 710B may be represented by [1,−1]. Additionally, with reference to OCC, each OCC codeword 710 may be orthogonal to each other (e.g., [1,1] is orthogonal to [1,−1].

After applying the respective OCC codewords 710 to the uplink messages 706, each device 704 may form a respective spread entity 712. For example, the first device 704A may form a first spread entity 712A for the first uplink message 706A, where the first spread entity 712A includes the first uplink message 706A with the first OCC codeword 710A applied (e.g., [1,1] applied to

$${s}_{1}^{0}$$

may correspond to

$${s}_{1}^{0} and {s}_{1}^{0} ) .$$

Additionally or alternatively, the second device 704B may form a second spread entity 712B for the second uplink message 706B, where the second spread entity 712B includes the second uplink message 706B with the second OCC codeword 710B applied (e.g., [1,−1] applied to

$${s}_{2}^{0}$$

may correspond to

$${s}_{2}^{0} and - {s}_{2}^{0} ) .$$

Accordingly, the first spread entity 712A and the second spread entity 712B may be orthogonal to each other (e.g.,

$${s}_{1}^{0} and - {s}_{2}^{0}$$

are orthogonal to each other). In some aspects, the respective spread entities 712 may be on a same RE (e.g., an OFDM symbol, an OFDM slot, an OFDM mini-slot), a subcarrier, or a combination thereof).

Subsequently, each device 704 may send the respective spread entities 712 via respective antennas 714. For example, the first device 704A may send the first spread entity 712A via a first antenna 714A, and the second device 704B may send the second spread entity 712B via a second antenna 714B. A network entity (e.g., BS 102, BS 180, satellite 140, NTN payload 524, network entity 602, etc.) may receive each spread entity 712 from each device 704 on one or more same time-frequency resources and may identify which device 704 sent which spread entity 712 and/or uplink message 706 based on the OCCs (e.g., the orthogonality between the spread entities 712).

### Example Operations of Entities in a Communications Network for Indicating OCC Configurations Via Antenna Port Indication

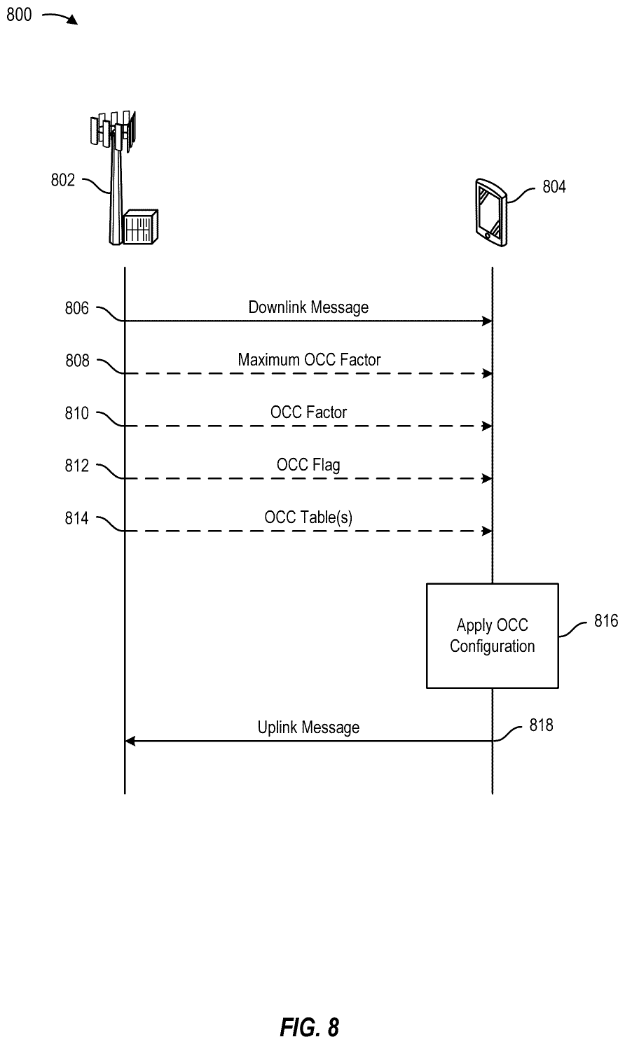

FIG. 8 depicts a process flow 800 for communications in a network between a network entity and a device for indicating OCC configurations via an antenna port indication in accordance with aspects of the present disclosure. In some aspects, the process flow 800 may implement aspects of or may be implemented by aspects of FIGS. 1-7. For example, the process flow 800 may include a network entity 802 and at least one device 804. The network entity 802 may represent a base station or similar network entity as described with reference to FIGS. 1-7 (e.g., BS 102, BS 180, satellite 140, NTN payload 524, network entity 602, etc.) and the device 804 may represent a UE or similar terminal device as described with reference to FIGS. 1-7 (e.g., UE 104, UE 504, device 604, etc.). In some aspects, the process flow 800 may represent a wireless communications network for indicating OCC configurations via an antenna port indication as described with reference to FIG. 6. Note that any operations or signaling illustrated with dashed lines may indicate that that operation or signaling is an optional or alternative example.

At 806, the device 804 receives (e.g., from the network entity 802) a downlink message that schedules an uplink message. In some aspects, the downlink message includes an antenna port field. For example, the downlink message may include a DCI message (e.g., carried in a PDCCH). Additionally, the antenna port field may include a logical transmit antenna port indication or a DMRS port indication. In some aspects, the network entity 802 and the device 804 may each include a single antenna. Additionally, the network entity 802 and the device 804 may be configured to operate in an NTN (e.g., the NTN 500 as described with reference to FIG. 5).

In some aspects, the antenna port field may correspond to an OCC configuration (e.g., the OCC configuration may include at least an OCC factor and an OCC codeword index or an OCC sequence as described with reference to FIGS. 6 and 7). For example, the antenna port field may indicate an entry within a table, where the table includes a plurality of OCC configurations and at least one non-OCC configuration (e.g., Tables 3, 4, and 5 as described with reference to FIG. 6), and each OCC configuration of the plurality of OCC configurations and the at least one non-OCC configuration may be associated with a respective value for the antenna port field. Additionally or alternatively, the antenna port field may indicate an entry within a table, where the table includes a plurality of OCC configurations, and each OCC configuration of the plurality of OCC configurations may be associated with a respective value for the antenna port field, where the respective value for the antenna port field includes a plurality of bits. In some aspects, an amount of the plurality of bits is dependent on a maximum length indication for a number of time resources for a DMRS (e.g., maxlength as described with reference to FIG. 6).

At 808, the device 804 may receive (e.g., from the network entity 802) an indication of a maximum OCC factor. For example, the device 804 may receive the indication of the maximum OCC factor via RRC signaling. In some aspects, the OCC configuration may be based on the maximum OCC factor. For example, the antenna port field may indicate an entry within a table, where the table includes a plurality of OCC configurations up to the maximum OCC factor (e.g., Tables 3, 5, 8, and 10 as described with reference to FIG. 6), and each OCC configuration of the plurality of OCC configurations may be associated with a respective value for the antenna port field.

At 810, the device 804 may receive (e.g., from the network entity 802) an indication of an OCC factor (e.g., an actual OCC factor as described with reference to FIG. 6) for the OCC configuration. For example, the device 804 may receive the indication of the OCC factor via RRC signaling or a DCI message. In some aspects, the antenna port field may indicate an entry within a table, where the table includes a plurality of OCC configurations for the OCC factor (e.g., Tables 6 and 7 as described with reference to FIG. 6), and each OCC configuration of the plurality of OCC configurations may be associated with a respective value for the antenna port field.

At 812, the device 804 may receive (e.g., from the network entity 802) an OCC flag (e.g., within the downlink message). For example, the OCC flag may indicate whether OCC is enabled or not for transmission of the uplink message. Subsequently, the OCC configuration may be based on the OCC flag. For example, if the OCC flag indicates that OCC is not enabled for transmission of the uplink message, then the device 804 may use a configuration for sending the uplink message that does not use OCC (e.g., according to Tables 1 and 2 as described with reference to FIG. 6). Additionally or alternatively, if the OCC flag indicates that OCC is enabled for transmission of the uplink message, then the device 804 may use an OCC configuration for sending the uplink message (e.g., according to Tables 6, 7, 8, 9, and 10 based on whether no OCC factor, a maximum OCC factor, or an actual OCC factor is configured as described with reference to FIG. 6). If the OCC flag indicates that OCC is enabled for transmission of the uplink message, then the tables used for determining an OCC configuration for transmission of the uplink message may not include non-OCC configurations.

At 814, the device 804 may receive (e.g., from the network entity 802) one or more OCC tables comprising a plurality of OCC configurations. Accordingly, the antenna port field may indicate the OCC configuration from the plurality of OCC configurations in one OCC table of the one or more OCC tables. In some aspects, the device 804 may receive the one or more OCC tables via at least one of: an RRC message, a PUSCH configuration IE (e.g., PUSCH-Config IE) in the RRC message, an IE within the PUSCH configuration IE, or DMRS-related IEs within the PUSCH configuration IE.

At 816, the device 804 may apply an OCC configuration to the uplink message. For example, if the antenna port field corresponds to an OCC configuration in a table and/or the OCC flag indicates that OCC is enabled for transmission of the uplink message, then the device 804 may apply the corresponding OCC configuration to the uplink message (e.g., as described with reference to FIGS. 6 and 7). Additionally or alternatively, if the antenna port field corresponds to a non-OCC configuration in a table and/or the OCC flag indicates that OCC is not enabled for transmission of the uplink message, then the device 804 may apply a non-OCC configuration to the uplink message (e.g., as described with reference to FIG. 6).

At 818, the device 804 may send (e.g., to the network entity 802) the uplink message based on an OCC configuration (e.g., or non-OCC configuration) that corresponds to the antenna port field. In some aspects, the uplink message may include a PUSCH message. For example, the uplink message may include a DMRS transmission or another type of uplink message sent via a PUSCH.

Note that the process flow illustrated in FIG. 8 is an example of indicating OCC configurations via an antenna port indication, and aspects of the present disclosure may be applied to indicating OCC configurations via an antenna port indication. Note that the process flow illustrated in FIG. 8 is described herein to facilitate an understanding of indicating OCC configurations via an antenna port indication, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

### Example Operations of a Device

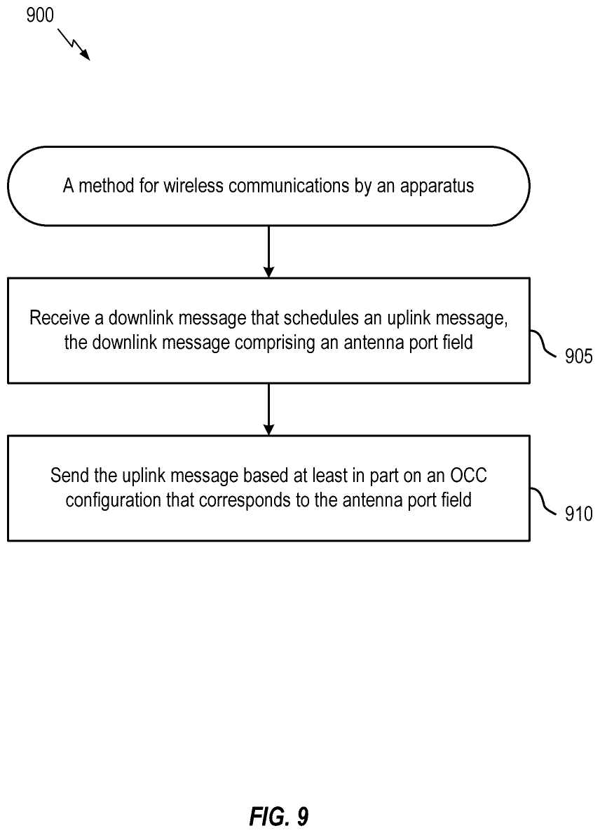

FIG. 9 shows a method 900 for wireless communications by an apparatus, such as UE 104 of FIGS. 1 and 3.

Method 900 begins at block 905 with receiving a downlink message (e.g., the downlink message 610 as described with reference to FIG. 6) that schedules an uplink message, the downlink message comprising an antenna port field (e.g., the antenna port field 612 as described with reference to FIG. 6).

Method 900 then proceeds to block 910 with sending the uplink message (e.g., the uplink message 618 as described with reference to FIG. 6) based at least in part on an OCC configuration that corresponds to the antenna port field.

In one aspect, method 900 further includes receiving an indication of a maximum OCC factor, where the OCC configuration is based at least in part on the maximum OCC factor.

In one aspect, method 900 further includes receiving the indication of the maximum OCC factor via RRC signaling.

In one aspect, the antenna port field indicates an entry within a table, the table comprises a plurality of OCC configurations up to the maximum OCC factor (e.g., Tables 3, 5, 8, and 10 as described with reference to FIG. 6), and each OCC configuration of the plurality of OCC configurations is associated with a respective value for the antenna port field.

In one aspect, method 900 further includes receiving an indication of an OCC factor for the OCC configuration.

In one aspect, method 900 further includes receiving the indication of the OCC factor via RRC signaling or a DCI message.

In one aspect, the antenna port field indicates an entry within a table, the table comprises a plurality of OCC configurations for the OCC factor (e.g., Tables 6 and 7 as described with reference to FIG. 6), and each OCC configuration of the plurality of OCC configurations is associated with a respective value for the antenna port field.

In one aspect, the antenna port field indicates an entry within a table, and the table comprises a plurality of OCC configurations and at least one non-OCC configuration (e.g., Tables 3, 4, and 5 as described with reference to FIG. 6), and each OCC configuration of the plurality of OCC configurations and the at least one non-OCC configuration is associated with a respective value for the antenna port field.

In one aspect, method 900 further includes receiving an OCC flag within the downlink message, where the OCC flag indicates whether OCC is enabled or not for transmission of the uplink message, and the OCC configuration is based at least in part on the OCC flag (e.g., according to Tables 1 and 2 as described with reference to FIG. 6 if the OCC flag indicates OCC is not enabled and/or according to Tables 6, 7, 8, 9, and 10 based on whether no OCC factor, a maximum OCC factor, or an actual OCC factor is configured as described with reference to FIG. 6 if the OCC flag indicates OCC is enabled).

In one aspect, method 900 further includes receiving one or more OCC tables comprising a plurality of OCC configurations (e.g., the one or more OCC tables 614 as described with reference to FIG. 6), where the antenna port field indicates the OCC configuration from the plurality of OCC configurations in one OCC table of the one or more OCC tables.

In one aspect, method 900 further includes receiving the one or more OCC tables via at least one of: a RRC message, a PUSCH configuration IE in the RRC message, an IE within the PUSCH configuration IE, or DMRS-related IEs within the PUSCH configuration IE.

In one aspect, the antenna port field indicates an entry within a table, the table comprises a plurality of OCC configurations (e.g., any of the Tables 3-10 as described with reference to FIG. 6), each OCC configuration of the plurality of OCC configurations is associated with a respective value for the antenna port field, and the respective value for the antenna port field comprises a plurality of bits.

In one aspect, the antenna port field comprises a plurality of bits, and an amount of the plurality of bits is dependent on a maximum length indication for a number of time resources for a DMRS (e.g., maxlength).

In one aspect, the OCC configuration comprises an OCC factor and an OCC codeword index or OCC sequence.

In one aspect, the downlink message comprises a DCI message, the antenna port field comprises a logical transmit antenna port indication or a DMRS port indication, and the uplink message comprises a PUSCH message.

In one aspect, the apparatus comprises a single antenna.

In one aspect, the apparatus is configured to operate in a NTN.

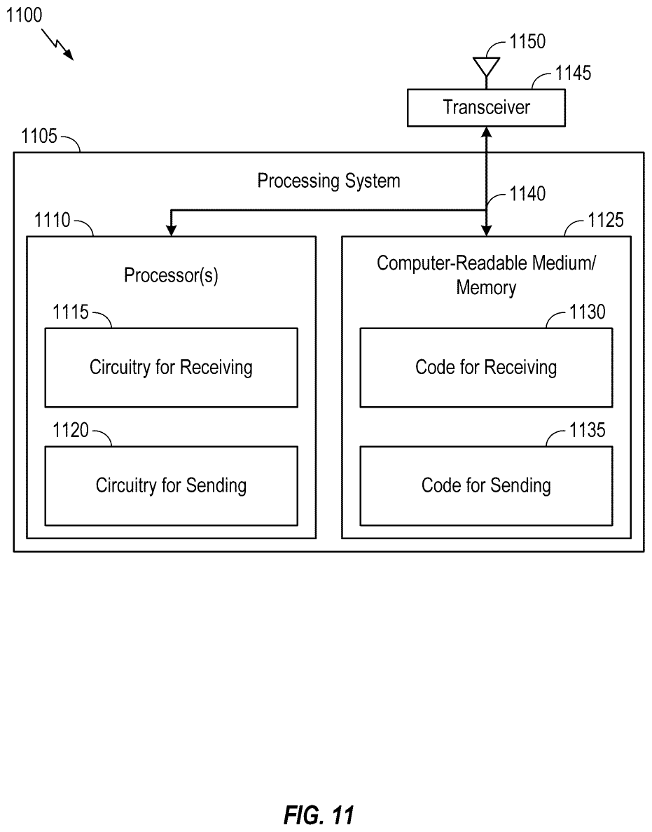

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

In certain aspects, method 900 may be performed by the apparatus to realize one or more technical effects or solutions to the aforementioned technical problem(s). For example, based on method 900, signaling overhead may be reduced by repurposing the antenna port field to indicate the OCC configurations (e.g., rather than indicating the OCC configurations in a separate field and/or downlink message). Additionally, using OCC for sending the uplink message may decrease interference from multiple devices attempting to send respective uplink messages on one or more same time-frequency resources, which may increase reliability for communications from the apparatus. Additionally, using OCC may increase resource efficiency for communications for the multiple devices (e.g., reduced channel usage, such as using fewer time-frequency resources).

### Example Operations of a Network Entity

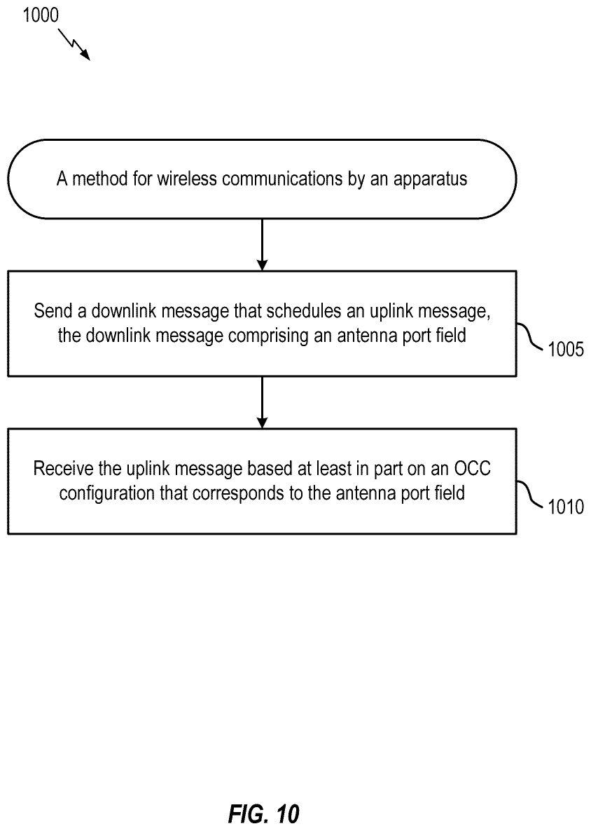

FIG. 10 shows a method 1000 for wireless communications by an apparatus, such as BS 102 of FIGS. 1 and 3, or a disaggregated base station as discussed with respect to FIG. 2.

Method 1000 begins at block 1005 with sending a downlink message (e.g., the downlink message 610 as described with reference to FIG. 6) that schedules an uplink message, the downlink message comprising an antenna port field (e.g., the antenna port field 612 as described with reference to FIG. 6).

Method 1000 then proceeds to block 1010 with receiving the uplink message (e.g., the uplink message 618 as described with reference to FIG. 6) based at least in part on an OCC configuration that corresponds to the antenna port field.

In certain aspects, method 1000 further includes sending an indication of a maximum OCC factor, where the OCC configuration is based at least in part on the maximum OCC factor.

In certain aspects, method 1000 further includes sending the indication of the maximum OCC factor via RRC signaling.

In one aspect, the antenna port field indicates an entry within a table, the table comprises a plurality of OCC configurations up to the maximum OCC factor (e.g., Tables 3, 5, 8, and 10 as described with reference to FIG. 6), and each OCC configuration of the plurality of OCC configurations is associated with a respective value for the antenna port field.

In certain aspects, method 1000 further includes sending an indication of an OCC factor for the OCC configuration.

In certain aspects, method 1000 further includes sending the indication of the OCC factor via RRC signaling or a DCI message.

In one aspect, the antenna port field indicates an entry within a table, the table comprises a plurality of OCC configurations for the OCC factor (e.g., Tables 6 and 7 as described with reference to FIG. 6), and each OCC configuration of the plurality of OCC configurations is associated with a respective value for the antenna port field.

In one aspect, the antenna port field indicates an entry within a table, and the table comprises a plurality of OCC configurations and at least one non-OCC configuration (e.g., Tables 3, 4, and 5 as described with reference to FIG. 6), and each OCC configuration of the plurality of OCC configurations and the at least one non-OCC configuration is associated with a respective value for the antenna port field.

In certain aspects, method 1000 further includes sending an OCC flag within the downlink message, where the OCC flag indicates whether OCC is enabled or not for transmission of the uplink message, and the OCC configuration is based at least in part on the OCC flag (e.g., according to Tables 1 and 2 as described with reference to FIG. 6 if the OCC flag indicates OCC is not enabled and/or according to Tables 6, 7, 8, 9, and 10 based on whether no OCC factor, a maximum OCC factor, or an actual OCC factor is configured as described with reference to FIG. 6 if the OCC flag indicates OCC is enabled).

In certain aspects, method 1000 further includes sending one or more OCC tables comprising a plurality of OCC configurations (e.g., the one or more OCC tables 614 as described with reference to FIG. 6), where the antenna port field indicates the OCC configuration from the plurality of OCC configurations in one OCC table of the one or more OCC tables.

In certain aspects, method 1000 further includes sending the one or more OCC tables via at least one of: a RRC message, a PUSCH configuration IE in the RRC message, an IE within the PUSCH configuration IE, or DMRS-related IEs within the PUSCH configuration IE.

In one aspect, the antenna port field indicates an entry within a table, the table comprises a plurality of OCC configurations (e.g., any of the Tables 3-10 as described with reference to FIG. 6), each OCC configuration of the plurality of OCC configurations is associated with a respective value for the antenna port field, and the respective value for the antenna port field comprises a plurality of bits.

In one aspect, the antenna port field comprises a plurality of bits, and an amount of the plurality of bits is dependent on a maximum length indication for a number of time resources for a DMRS (e.g., maxlength).

In one aspect, the OCC configuration comprises an OCC factor and an OCC codeword index or OCC sequence.

In one aspect, the downlink message comprises a DCI message, the antenna port field comprises a logical transmit antenna port indication or a DMRS port indication, and the uplink message comprises a PUSCH message.

In one aspect, the apparatus comprises a single antenna.

In one aspect, the apparatus is configured to operate in a NTN.

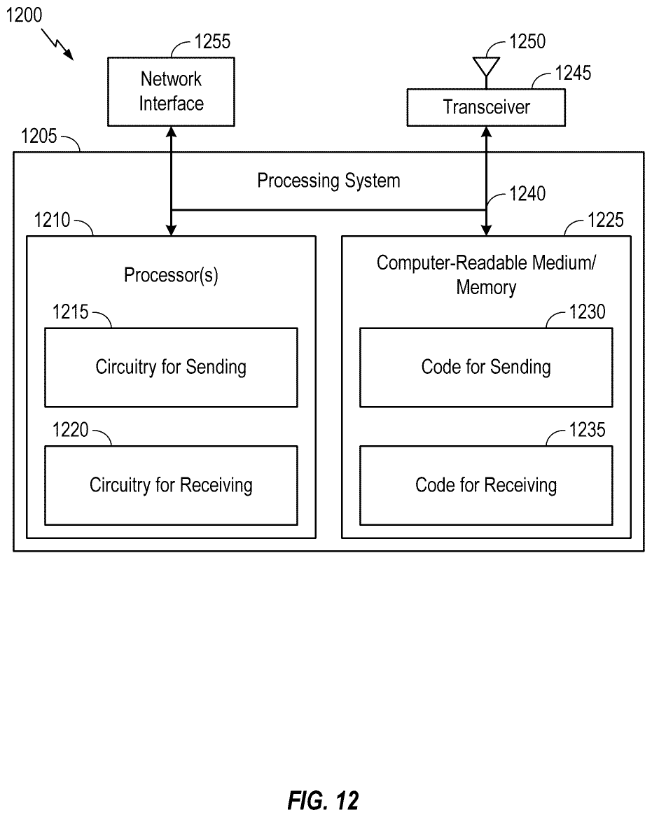

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

In certain aspects, method 1000 may be performed by the apparatus to realize one or more technical effects or solutions to the aforementioned technical problem(s). For example, based on method 1000, the apparatus may reduce signaling overhead by repurposing the antenna port field to indicate the OCC configurations (e.g., rather than indicating the OCC configurations in a separate field and/or downlink message). Additionally, using OCC for receiving the uplink message may decrease interference from multiple devices attempting to send respective uplink messages on one or more same time-frequency resources, which may increase reliability for communications received at the apparatus. Additionally, using OCC may increase resource efficiency for communications for the multiple devices (e.g., reduced channel usage, such as using fewer time-frequency resources).

### Example Communications Device

FIG. 11 depicts aspects of an example communications device 1100. In some aspects, communications device 1100 is a user equipment, such as UE 104 described above with respect to FIGS. 1 and 3.

The communications device 1100 includes a processing system 1105 coupled to a transceiver 1145 (e.g., a transmitter and/or a receiver). The transceiver 1145 is configured to transmit and receive signals for the communications device 1100 via an antenna 1150, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1125 via a bus 1140. In certain aspects, the computer-readable medium/memory 1125 is configured to store instructions (e.g., computer-executable code), including code 1130 and 1135, that when executed by the one or more processors 1110, enable and cause the one or more processors 1110 to perform the method 900 described with respect to FIG. 9, or any aspect related to it, including any operations described in relation to FIG. 9. Note that reference to a processor performing a function of communications device 1100 may include one or more processors performing that function of communications device 1100, such as in a distributed fashion.

In the depicted example, computer-readable medium/memory 1125 stores code for receiving 1130 and code for sending 1135. Processing of the code 1130 and 1135 may enable and cause the communications device 1100 to perform the method 900 described with respect to FIG. 9, or any aspect related to it.

The one or more processors 1110 include circuitry configured to implement (e.g., execute) the code (e.g., executable instructions) stored in the computer-readable medium/memory 1125, including circuitry for receiving 1115 and circuitry for sending 1120. Processing with circuitry 1115 and 1120 may enable and cause the communications device 1100 to perform the method 900 described with respect to FIG. 9, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1145 and/or antenna 1150 of the communications device 1100 in FIG. 11, and/or one or more processors 1110 of the communications device 1100 in FIG. 11. Means for communicating, receiving or obtaining may include the transceivers 354, antenna(s) 352, receive processor 358, AI processor 370, and/or controller/processor 380 of the UE 104 illustrated in FIG. 3, transceiver 1145 and/or antenna 1150 of the communications device 1100 in FIG. 11, and/or one or more processors 1110 of the communications device 1100 in FIG. 11.

FIG. 12 depicts aspects of an example communications device 1200. In some aspects, communications device 1200 is a network entity, such as BS 102 of FIGS. 1 and 3, or a disaggregated base station as discussed with respect to FIG. 2.

The communications device 1200 includes a processing system 1205 coupled to a transceiver 1245 (e.g., a transmitter and/or a receiver) and/or a network interface 1255. The transceiver 1245 is configured to transmit and receive signals for the communications device 1200 via an antenna 1250, such as the various signals as described herein. The network interface 1255 is configured to obtain and send signals for the communications device 1200 via communications link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1225 via a bus 1240. In certain aspects, the computer-readable medium/memory 1225 is configured to store instructions (e.g., computer-executable code), including code 1230 and 1235, that when executed by the one or more processors 1210, enable and cause the one or more processors 1210 to perform the method 1000 described with respect to FIG. 10, or any aspect related to it, including any operations described in relation to FIG. 10. Note that reference to a processor of communications device 1200 performing a function may include one or more processors of communications device 1200 performing that function, such as in a distributed fashion.

In the depicted example, the computer-readable medium/memory 1225 stores code for sending 1230 and code for receiving 1235. Processing of the code 1230 and 1235 may enable and cause the communications device 1200 to perform the method 1000 described with respect to FIG. 10, or any aspect related to it.

The one or more processors 1210 include circuitry configured to implement (e.g., execute) the code (e.g., executable instructions) stored in the computer-readable medium/memory 1225, including circuitry for sending 1215 and circuitry for receiving 1220. Processing with circuitry 1215 and 1220 may enable and cause the communications device 1200 to perform the method 1000 described with respect to FIG. 10, or any aspect related to it.

Various components of the communications device 1200 may provide means for performing the method 1000 described with respect to FIG. 10, or any aspect related to it. Means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1245, antenna 1250, and/or network interface 1255 of the communications device 1200 in FIG. 12, and/or one or more processors 1210 of the communications device 1200 in FIG. 12. Means for communicating, receiving or obtaining may include the transceivers 332, antenna(s) 334, receive processor 338, AI processor 318, and/or controller/processor 340 of the BS 102 illustrated in FIG. 3, transceiver 1245, antenna 1250, and/or network interface 1255 of the communications device 1200 in FIG. 12, and/or one or more processors 1210 of the communications device 1200 in FIG. 12.

### EXAMPLE CLAUSES

Implementation examples are described in the following numbered clauses:

Clause 1: A method for wireless communications by an apparatus comprising: receiving a downlink message that schedules an uplink message, the downlink message comprising an antenna port field; and sending the uplink message based at least in part on an OCC configuration that corresponds to the antenna port field.

Clause 2: The method of Clause 1, further comprising receiving an indication of a maximum OCC factor, where the OCC configuration is based at least in part on the maximum OCC factor.

Clause 3: The method of Clause 2, further comprising receiving the indication of the maximum OCC factor via RRC signaling.

Clause 4: The method of Clause 2, wherein: the antenna port field indicates an entry within a table, the table comprises a plurality of OCC configurations up to the maximum OCC factor, and each OCC configuration of the plurality of OCC configurations is associated with a respective value for the antenna port field.

Clause 5: The method of any one of Clauses 1-4, further comprising receiving an indication of an OCC factor for the OCC configuration.

Clause 6: The method of Clause 5, further comprising receiving the indication of the OCC factor via RRC signaling or a DCI message.

Clause 7: The method of Clause 5, wherein: the antenna port field indicates an entry within a table, the table comprises a plurality of OCC configurations for the OCC factor, and each OCC configuration of the plurality of OCC configurations is associated with a respective value for the antenna port field.

Clause 8: The method of any one of Clauses 1-7, wherein: the antenna port field indicates an entry within a table, and the table comprises a plurality of OCC configurations and at least one non-OCC configuration, and each OCC configuration of the plurality of OCC configurations and the at least one non-OCC configuration is associated with a respective value for the antenna port field.

Clause 9: The method of any one of Clauses 1-8, further comprising receiving an OCC flag within the downlink message, where the OCC flag indicates whether OCC is enabled or not for transmission of the uplink message, and the OCC configuration is based at least in part on the OCC flag.

Clause 10: The method of any one of Clauses 1-9, further comprising receiving one or more OCC tables comprising a plurality of OCC configurations, where the antenna port field indicates the OCC configuration from the plurality of OCC configurations in one OCC table of the one or more OCC tables.

Clause 11: The method of Clause 10, further comprising receiving the one or more OCC tables via at least one of: a RRC message, a PUSCH configuration IE in the RRC message, an IE within the PUSCH configuration IE, or DMRS-related IEs within the PUSCH configuration IE.

Clause 12: The method of any one of Clauses 1-11, wherein: the antenna port field indicates an entry within a table, the table comprises a plurality of OCC configurations, each OCC configuration of the plurality of OCC configurations is associated with a respective value for the antenna port field, and the respective value for the antenna port field comprises a plurality of bits.

Clause 13: The method of any one of Clauses 1-12, wherein: the antenna port field comprises a plurality of bits, and an amount of the plurality of bits is dependent on a maximum length indication for a number of time resources for a DMRS.

Clause 14: The method of any one of Clauses 1-13, wherein the OCC configuration comprises an OCC factor and an OCC codeword index or OCC sequence.

Clause 15: The method of any one of Clauses 1-14, wherein: the downlink message comprises a DCI message, the antenna port field comprises a logical transmit antenna port indication or a DMRS port indication, and the uplink message comprises a PUSCH message.

Clause 16: The method of any one of Clauses 1-15, wherein the apparatus comprises a single antenna.

Clause 17: The method of any one of Clauses 1-16, wherein the apparatus is configured to operate in a NTN.

Clause 18: A method for wireless communications by an apparatus comprising: sending a downlink message that schedules an uplink message, the downlink message comprising an antenna port field; and receiving the uplink message based at least in part on an OCC configuration that corresponds to the antenna port field.

Clause 19: The method of Clause 18, further comprising sending an indication of a maximum OCC factor, where the OCC configuration is based at least in part on the maximum OCC factor.

Clause 20: The method of Clause 19, further comprising sending the indication of the maximum OCC factor via RRC signaling.

Clause 21: The method of Clause 19, wherein: the antenna port field indicates an entry within a table, the table comprises a plurality of OCC configurations up to the maximum OCC factor, and each OCC configuration of the plurality of OCC configurations is associated with a respective value for the antenna port field.

Clause 22: The method of any one of Clauses 18-21, further comprising sending an indication of an OCC factor for the OCC configuration.

Clause 23: The method of Clause 22, further comprising sending the indication of the OCC factor via RRC signaling or a DCI message.

Clause 24: The method of Clause 22, wherein: the antenna port field indicates an entry within a table, the table comprises a plurality of OCC configurations for the OCC factor, and each OCC configuration of the plurality of OCC configurations is associated with a respective value for the antenna port field.

Clause 25: The method of any one of Clauses 18-24, wherein: the antenna port field indicates an entry within a table, and the table comprises a plurality of OCC configurations and at least one non-OCC configuration, and each OCC configuration of the plurality of OCC configurations and the at least one non-OCC configuration is associated with a respective value for the antenna port field.

Clause 26: The method of any one of Clauses 18-25, further comprising sending an OCC flag within the downlink message, where the OCC flag indicates whether OCC is enabled or not for transmission of the uplink message, and the OCC configuration is based at least in part on the OCC flag.

Clause 27: The method of any one of Clauses 18-26, further comprising sending one or more OCC tables comprising a plurality of OCC configurations, where the antenna port field indicates the OCC configuration from the plurality of OCC configurations in one OCC table of the one or more OCC tables.

Clause 28: The method of Clause 27, further comprising sending the one or more OCC tables via at least one of: a RRC message, a PUSCH configuration IE in the RRC message, an IE within the PUSCH configuration IE, or DMRS-related IEs within the PUSCH configuration IE.

Clause 29: The method of any one of Clauses 18-28, wherein: the antenna port field indicates an entry within a table, the table comprises a plurality of OCC configurations, each OCC configuration of the plurality of OCC configurations is associated with a respective value for the antenna port field, and the respective value for the antenna port field comprises a plurality of bits.

Clause 30: The method of any one of Clauses 18-29, wherein: the antenna port field comprises a plurality of bits, and an amount of the plurality of bits is dependent on a maximum length indication for a number of time resources for a DMRS.

Clause 31: The method of any one of Clauses 18-30, wherein the OCC configuration comprises an OCC factor and an OCC codeword index or OCC sequence.

Clause 32: The method of any one of Clauses 18-31, wherein: the downlink message comprises a DCI message, the antenna port field comprises a logical transmit antenna port indication or a DMRS port indication, and the uplink message comprises a PUSCH message.

Clause 33: The method of any one of Clauses 18-32, wherein the apparatus comprises a single antenna.

Clause 34: The method of any one of Clauses 18-33, wherein the apparatus is configured to operate in a NTN.

Clause 35: One or more apparatuses, comprising: one or more memories comprising executable instructions; and one or more processors configured to execute the executable instructions and cause the one or more apparatuses to perform a method in accordance with any one of Clauses 1-34.

Clause 36: One or more apparatuses, comprising: one or more memories; and one or more processors, coupled to the one or more memories, configured to cause the one or more apparatuses to perform a method in accordance with any one of Clauses 1-34.

Clause 37: One or more apparatuses, comprising: one or more memories; and one or more processors, coupled to the one or more memories, configured to perform a method in accordance with any one of Clauses 1-34.

Clause 38: One or more apparatuses, comprising means for performing a method in accordance with any one of Clauses 1-34.

Clause 39: One or more non-transitory computer-readable media comprising executable instructions that, when executed by one or more processors of one or more apparatuses, cause the one or more apparatuses to perform a method in accordance with any one of Clauses 1-34.

Clause 40: One or more computer program products embodied on one or more computer-readable storage media comprising code for performing a method in accordance with any one of Clauses 1-34.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
receive a downlink message that schedules an uplink message, the downlink message comprising an antenna port field; and
send the uplink message based at least in part on an orthogonal cover code (OCC) configuration that corresponds to the antenna port field.

2. The apparatus of claim 1, wherein the processing system is configured to cause the UE to receive an indication of an OCC factor for the OCC configuration.

3. The apparatus of claim 2, wherein the processing system is configured to cause the UE to receive the indication of the OCC factor via radio resource control (RRC) signaling or a downlink control information (DCI) message.

4. The apparatus of claim 2, wherein:
the antenna port field indicates an entry within a table,
the table comprises a plurality of OCC configurations for the OCC factor, and
each OCC configuration of the plurality of OCC configurations is associated with a respective value for the antenna port field.

5. The apparatus of claim 1, wherein:
the one or more processors are configured to cause the apparatus to receive an OCC flag within the downlink message,
the OCC flag indicates whether OCC is enabled or not for transmission of the uplink message, and
the OCC configuration is based at least in part on the OCC flag.

6. The apparatus of claim 1, wherein:
the processing system is configured to cause the UE to receive one or more OCC tables comprising a plurality of OCC configurations, and
the antenna port field indicates the OCC configuration from the plurality of OCC configurations in one OCC table of the one or more OCC tables.

7. The apparatus of claim 6, wherein the processing system is configured to cause the UE to receive the one or more OCC tables via at least one of: a radio resource control (RRC) message, a physical uplink shared channel (PUSCH) configuration information element (IE) in the RRC message, an IE within the PUSCH configuration IE, or demodulation reference signal (DMRS)-related IEs within the PUSCH configuration IE.

8. The apparatus of claim 1, wherein:
the antenna port field indicates an entry within a table,
the table comprises a plurality of OCC configurations,
each OCC configuration of the plurality of OCC configurations is associated with a respective value for the antenna port field, and
the respective value for the antenna port field comprises a plurality of bits.

9. The apparatus of claim 1, wherein:
the antenna port field comprises a plurality of bits, and
an amount of the plurality of bits is dependent on a maximum length indication for a number of time resources for a demodulation reference signal (DMRS).

10. The apparatus of claim 1, wherein the OCC configuration comprises an OCC factor and an OCC codeword index or OCC sequence.

11. The apparatus of claim 1, wherein:
the downlink message comprises a downlink control information (DCI) message,
the antenna port field comprises a logical transmit antenna port indication or a demodulation reference signal (DMRS) port indication, and
the uplink message comprises a physical uplink shared channel (PUSCH) message.

12. The apparatus of claim 1, wherein:
the processing system is configured to cause the UE to receive an indication of a maximum OCC factor, and
the OCC configuration is based at least in part on the maximum OCC factor.

13. The apparatus of claim 12, wherein the processing system is configured to cause the UE to receive the indication of the maximum OCC factor via radio resource control (RRC) signaling.

14. The apparatus of claim 12, wherein:
the antenna port field indicates an entry within a table,
the table comprises a plurality of OCC configurations up to the maximum OCC factor, and
each OCC configuration of the plurality of OCC configurations is associated with a respective value for the antenna port field.

15. The apparatus of claim 1, wherein:
the antenna port field indicates an entry within a table,
the table comprises a plurality of OCC configurations and at least one non-OCC configuration, and
each OCC configuration of the plurality of OCC configurations and the at least one non-OCC configuration is associated with a respective value for the antenna port field.

16. The apparatus of claim 1, wherein the UE comprises a single antenna.

17. The apparatus of claim 1, wherein the UE is configured to operate in a non-terrestrial network (NTN).

18. An apparatus for wireless communications, comprising a processing system that includes one or more processors and one or more memories coupled with the one or more processors, the processing system configured to cause a network entity to:
send a downlink message that schedules an uplink message, the downlink message comprising an antenna port field; and
receive the uplink message based at least in part on an orthogonal cover code (OCC) configuration that corresponds to the antenna port field.

19. The apparatus of claim 18, wherein:
the processing system is configured to cause the network entity to send an OCC flag within the downlink message,
the OCC flag indicates whether OCC is enabled or not for transmission of the uplink message, and
the OCC configuration is based at least in part on the OCC flag.

20. A method for wireless communications by an apparatus comprising:
receiving a downlink message that schedules an uplink message, the downlink message comprising an antenna port field; and
sending the uplink message based at least in part on an orthogonal cover code (OCC) configuration that corresponds to the antenna port field.
